(19) United States
(12) Patent Application Publication
(10) Pub. No.: US 2024/0406231 A1
(43) Pub. Date: Dec. 5, 2024

(54) HYBRID ENVIRONMENT FOR INTERACTIONS BETWEEN VIRTUAL AND PHYSICAL USERS

(71) Applicant: Microsoft Technology Licensing, LLC, Redmond, WA (US)

(72) Inventors: Venkata N. PADMANABHAN, Bengaluru (IN); Ajay MANCHEPALLI, Sammamish, WA (US); Harsh VIJAY, Bengaluru (IN); Sirish GAMBHIRA, Bengaluru (IN); Amish MITTAL, Bengaluru (IN); Saumay PUSHP, Bengaluru (IN); Praveen GUPTA, Bengaluru (IN); Mayank BARANWAL, Bengaluru (IN); Shivang CHOPRA, Bengaluru (IN); Meghna GUPTA, Bengaluru (IN); Arshia ARYA, Bengaluru (IN)

(73) Assignee: Microsoft Technology Licensing, LLC, Redmond, WA (US)

(21) Appl. No.: 18/358,485

(22) Filed: Jul. 25, 2023

(30) Foreign Application Priority Data
May 31, 2023 (IN) 202311037595

(51) Int. Cl. H04L 65/401; H04L 65/1069; H04L 65/1089; H04L 65/1093; H04L 65/403

(52) U.S. Cl. CPC H04L 65/4015; H04L 65/1069; H04L 65/1089; H04L 65/1093; H04L 65/403

(57) ABSTRACT

A data processing system implements a hybrid environment for interactions between remote and in-person users. The data processing techniques provide tools for facilitating mingling of remote and in-person users in semi-structured interaction, such as but not limited to tradeshows or conferences, and unstructured interactions, such as but not limited to social gatherings that solve the technical problems associated with enabling such systems. The data processing system implements audio porosity and map-based navigation to facilitate improved spatial awareness and awareness of the presence of other remote or in-person users nearby with whom the user can interact.

### BACKGROUND

Remote work has become a norm in recent years due to various factors including the global pandemic and changing attitudes toward commuting and work-life balance. A result of this trend is a hybrid work environment in which a portion of the workforce is remote, and a portion of the workforce is physically present at the office creating a hybrid work environment. This trend has also extended to events, such as a conferences and presentations, in which some attendees are physically present in person and while others attend remotely.

Current teleconferencing platforms are designed for structured interactions via scheduled meetings that have a predetermined agenda, set of invitees, and a dominant speaker or speakers who present information during the meeting. However, the current teleconferencing platforms do not support unstructured or semi-structured interactions between remote and in-person users that are available to users who are physically present at a meeting or event venue. Interactions may occur in a breakroom or hallway where those who are physically present can mingle in an unstructured or semi-structured environment. But the remote users are unable to participate in such interactions using current teleconferencing platforms. Hence, there is a need for improved systems and methods of facilitating hybrid interactions between remote and in person users in unstructured and semi-structured settings as well as structured ones.

### SUMMARY

An example data processing system according to the disclosure may include a processor and a machine-readable medium storing executable instructions. The instructions when executed cause the processor to perform operations including establishing a first group video call with a first communication portal at a first location within a physical space, the first communication portal providing audiovisual communications between in-person users located within a first zone at the first location within the physical space and first remote users located at one or more remote locations not at the physical space via the first group video call; establishing a second group video call with a second communication portal at a second location within the physical space, the second communication portal providing audiovisual communications between in-person users located within a second zone at the second location within the physical space and second remote users located at one or more remote locations not at the physical space via the second group video call; connecting first client devices associated with each user of the first remote users and second client devices associated with the second remote users with the first group video call and the second group video call; causing the first client devices to participate in the first group video call; causing the second client devices to participate in the first group video call; receiving a first navigation signal from a first client device of a first remote user of the first remote users to navigate from the first zone associated with the first communication portal to the second zone associated with the second communication portal; causing the first client device to stop participating in a video portion of the first group call in response to the first remote user exiting the first zone; attenuating a volume of an audio portion of the first group video call as the first remote user navigates from the first zone to the second zone; and causing the first client device to participate in the audio and video portions of the second group call in response to the first remote user entering the second zone.

An example method implemented in a data processing system for providing a hybrid environment for interactions between remote and in-person users includes receiving a first request to set up a first communication session with a first communication portal at a first location within a physical space, the first communication portal providing audiovisual communications between in-person users located within a first zone at the first location within the physical space and first remote users located at one or more remote locations not at the physical space; establishing a connection for each client device of a plurality of first client devices of the first remote users to a first group video call associated with the first communication portal; receiving a second request to set up a second communication session with a second communication portal at a second location within the physical space, the second communication portal providing audiovisual communications between in-person users located within a second zone at the second location within the physical space and second remote users located at one or more remote locations not at the physical space; establishing a connection for each client device of a plurality of second client devices of the second remote users to a second group video call associated with the second communication portal; causing client devices of the first remote users and the second remote users to present a navigation interface that provides a virtual representation of the physical space comprising map of the physical space and positions of the first communication portal and the second communication portal within the physical space; receiving a first navigation signal from a first client device of a first remote user of the first remote users to navigate from the first zone associated with the first communication portal to the second zone associated with the second communication portal; attenuating a volume of an audio portion of the first group video call as the first remote user navigates from the first zone to the second zone; disconnecting the first remote user from the first group video call user responsive to first remote user exiting the first zone and navigating more than a threshold disconnection distance from the first zone within the virtual representation of the physical space; establishing a connection for the first client device of the first remote user to the second group video call to enable the first remote user to communicate with the in-person users at the second location and the second remote users responsive to the first user navigating to less than a threshold connection distance from the second zone within the virtual representation of the physical space.

An example data processing system according to the disclosure may include a processor and a machine-readable medium storing executable instructions. The instructions when executed cause the processor to perform operations including receiving a request from a first client device of a first remote user to connect to a communication session that includes a plurality of in-person users located within a physical space and a plurality of remote users located at one or more remote locations not at the physical space, the physical space being segmented into a plurality of zones, each zone being associated with a communication portal that includes a display for presenting video received from the client devices of remote users and a speaker for presenting audio received from the client devices of the remote users who have navigated to the zone in a virtual representation of the physical space, the communication portal further including a camera for capturing video of the in-person users who are physically present in the zone and a microphone for capturing audio of the in-person users who are physically present in the zone; receiving a first navigation indication from the first client device of the first remote user indicating that the first remote user has navigated to a first zone within the virtual representation of the physical space; connecting the first client device of the first remote user with a first group video call associated with a first communication portal associated with the first zone; streaming first audiovisual content of the in-person users present in the first zone captured by the first communication portal to the first client device responsive to connecting the first client device with the first group video call; streaming second audiovisual content of the first remote user captured by the first client device to the first communication portal responsive to connecting the first client device with the first group video call; receiving a second navigation indication from the first client device that the first remote user has navigated from the first zone to a second zone within the virtual representation of the physical space; disabling a video portion of the first video call to and from the first client device responsive to the first remote user navigating from the first zone to the second zone; connecting the first client device of the first remote user with a second group video call associated with a second communication portal associated with the second zone; streaming third audiovisual content of the in-person users present in the first zone captured by the second communication portal to the first client device responsive to connecting the first client device with the second group video call, the third audiovisual content including an audio portion of the first audiovisual content for which a volume level of the first audiovisual content has been attenuated in proportion to how far an avatar representing the first remote user travels from the first zone within the virtual representation of the physical space; and streaming fourth audiovisual content of the first remote user captured by the first client device to the second communication portal responsive to connecting the first client device with the second group video call.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing aspects of an example computing environment in which the techniques for providing a hybrid environment that promotes interactions between remote and in-person users are implemented.

FIGS. 2A-2I are examples of a map interface that may be implemented by the communication services platform shown in FIG. 1.

FIG. 3 is a diagram showing additional features of the call support services and the identity management services shown in FIG. 1.

FIGS. 4A-4F are diagrams of example user interfaces of a communication application that incorporates the techniques provided herein to provide a hybrid environment for interactions between remote and in-person users.

FIG. 5A is an example of an identity mapping data structure that is implemented by the identity mapping datastore of the identity management services in some implementations.

FIG. 5B is an example of a portal information data structure for storing information associated with the communication portals.

FIG. 6A is a flow chart of an example process for providing a hybrid environment for interactions between remote and in-person users according to the techniques provided herein.

FIG. 6B is a flow chart of another example process for providing a hybrid environment for interactions between remote and in-person users according to the techniques provided herein.

FIG. 6C is a flow chart of another example process for providing a hybrid environment for interactions between remote and in-person users according to the techniques provided herein.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

FIG. 9 is a diagram that shows the interactions between a communication portal and the communication services platform.

FIG. 10 is a flow chart of an example process for setting up and supporting a communication session according to the techniques provided herein.

### DETAILED DESCRIPTION

Techniques for implementing a hybrid environment for interactions between remote and in-person users are provided. These techniques provide tools for facilitating mingling of remote and in-person users in semi-structured interaction and unstructured interactions that solve the technical problems associated with enabling such systems. An example of a semi-structured interaction is trade show or a poster session at a conference, and an example of an unstructured interaction would be a social gathering such as but not limited to a coffee break in a hallway at the conference. Current teleconferencing platforms provide for scheduled, structured interactions in which participants are known and invited to participate in advance. Such platforms are not designed for the dynamic and impromptu interactions that often occur in semi-structured or unstructured environments. The participants who are physically present in such semi-structure or unstructured environments can mingle with others who are also physically present, which leads to impromptu conversations among the participants. Those participants who are physically present are aware of the presence of others around them. If the participants see or overhear something that catches their interest, they have the agency to move and join another conversation. However, hybrid environments that include both remote and in-person users have an awareness gap between the remote and in-person users. The techniques herein bridge the awareness gap between remote and in-person users through reciprocity, porosity, and map-based awareness. Reciprocity ensures that both the in-person users and remote users can see and hear other users only if they themselves can be seen and heard. Porosity ensure that users engaged in a conversation with in-person and/or remote users can overhear nearby conversations. Map-based awareness provides a skeuomorphic representation of the meeting or event space, overlaid with avatars representing in-person and remote users, allowing users to be aware of other in-person or remote users nearby. These and other technical benefits of the techniques disclosed herein will be evident from the discussion of the example implementations that follow.

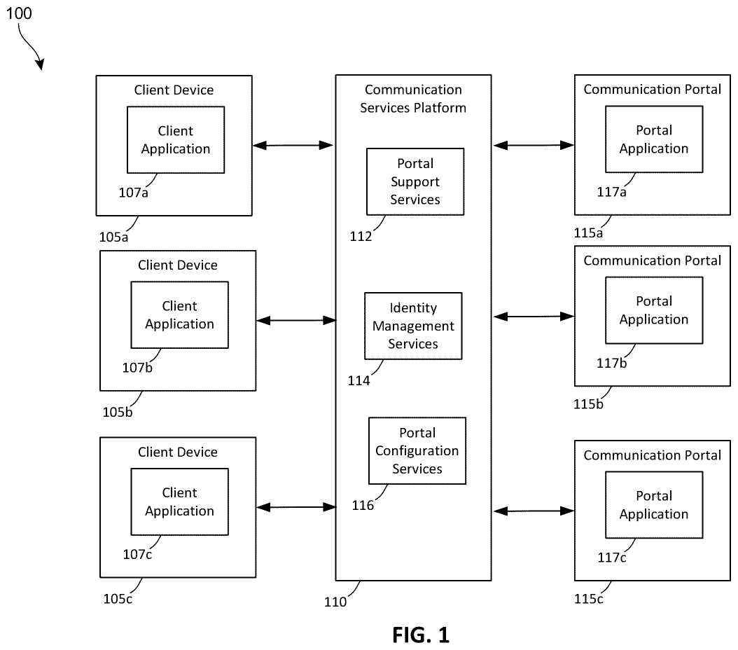

FIG. 1 is a diagram shown an example computing environment 100 in which the techniques for providing a hybrid environment for interactions between remote and in-person users herein are implemented. The communication services platform 110 is configured to facilitate interactions between in-person users and remote users (also referred to herein as virtual users). The computing environment 100 also includes client devices 105a, 105b, and 105c (collectively referred to as client device 105) and communication portals 115a, 115b, and 115c (collectively referred to as communication portal 115) which are placed at different physical locations throughout the physical space in which the hybrid environment is being implemented. This physical space may be an event venue, an office, or other such physical space in which remote and in-person users may mingle.

The communication services platform 110 is implemented as a cloud-based service or set of services. The communication services platform 110 is configured to facilitate reciprocity, porosity, and map-based awareness to bridge the awareness gap between the remote users and the in-person users. The communication services platform 110 utilizes the techniques provided herein to provide the users tools for setting up and participating in hybrid communication sessions. The communication services platform 110 includes portal support services 112, identity management service 114, and portal configuration services 116.

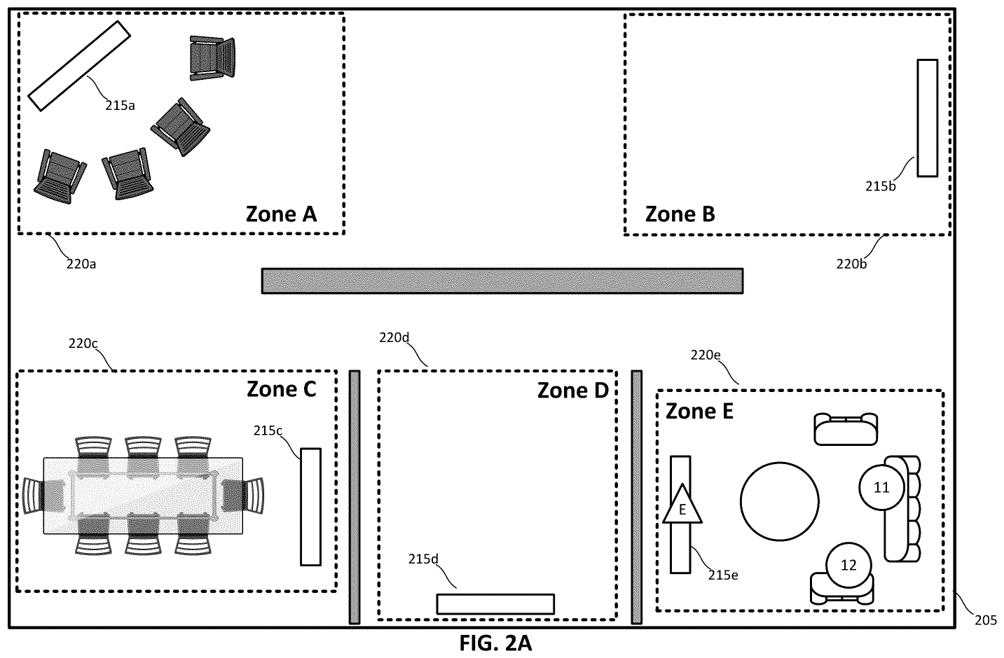

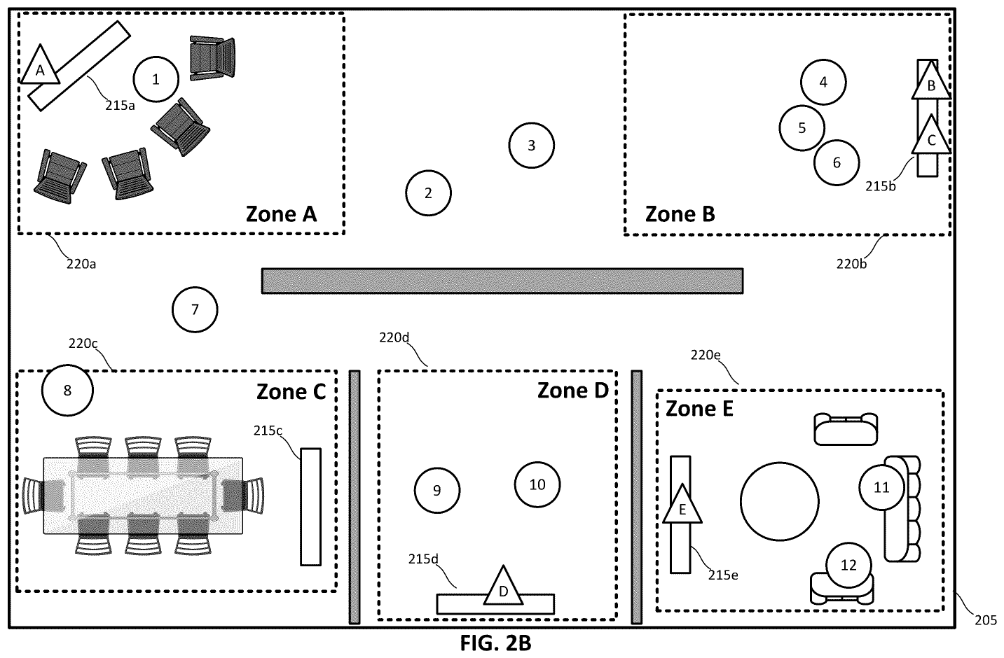

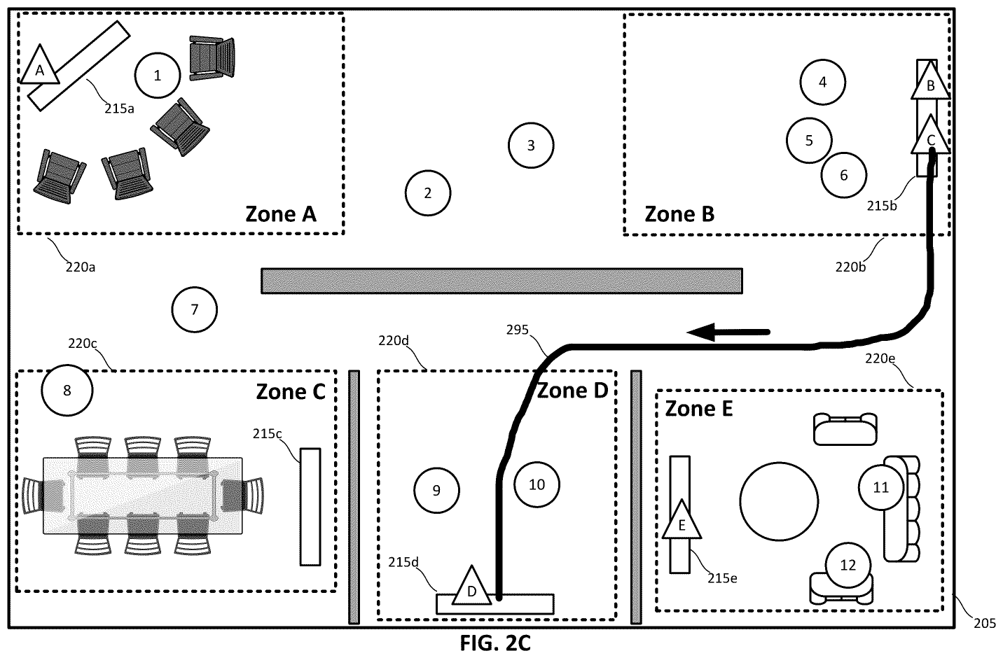

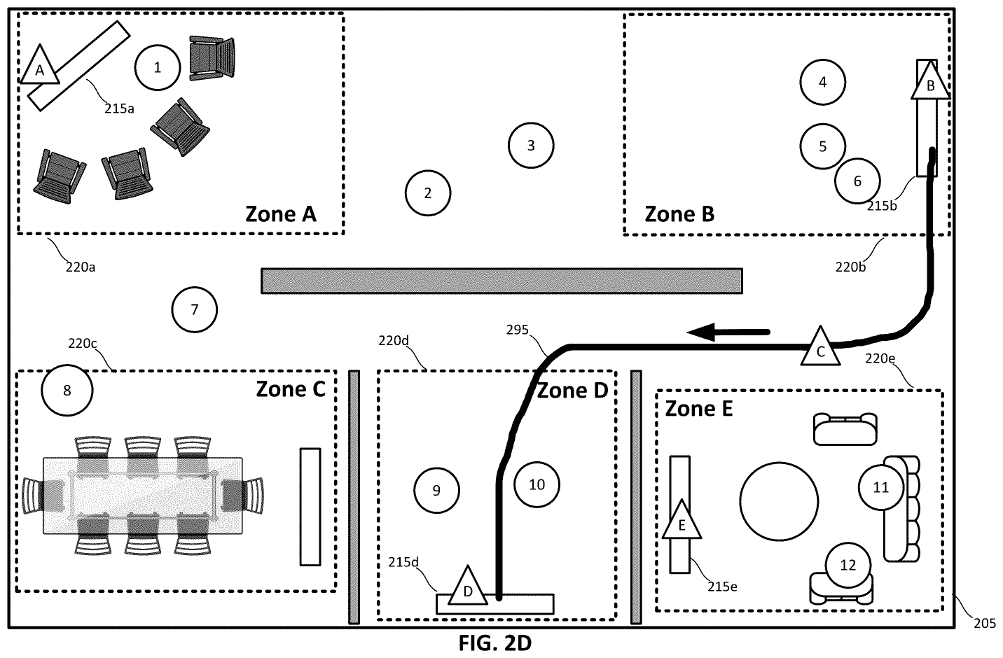

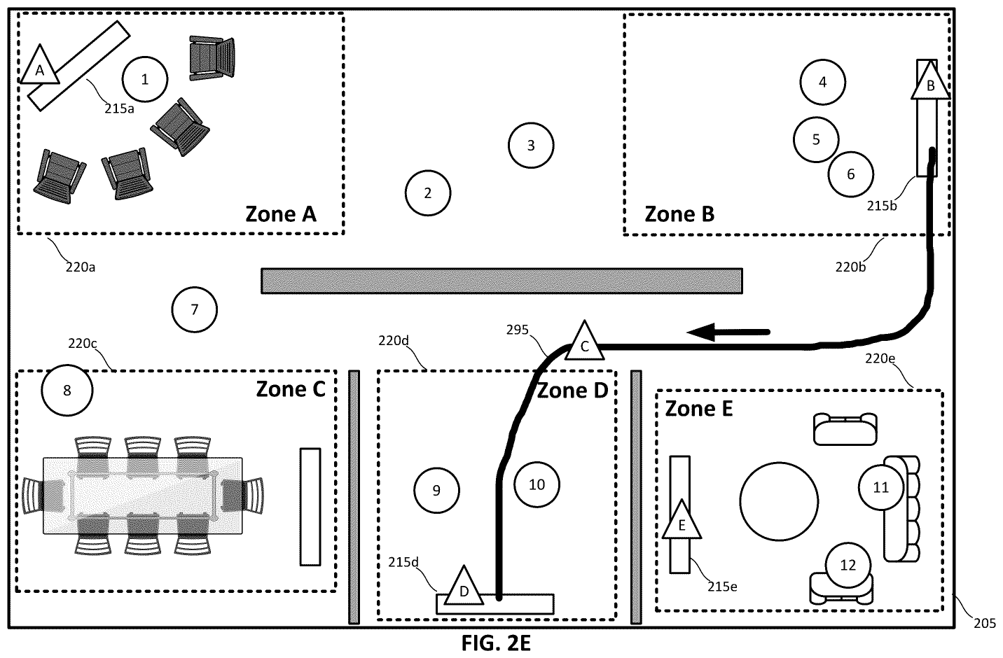

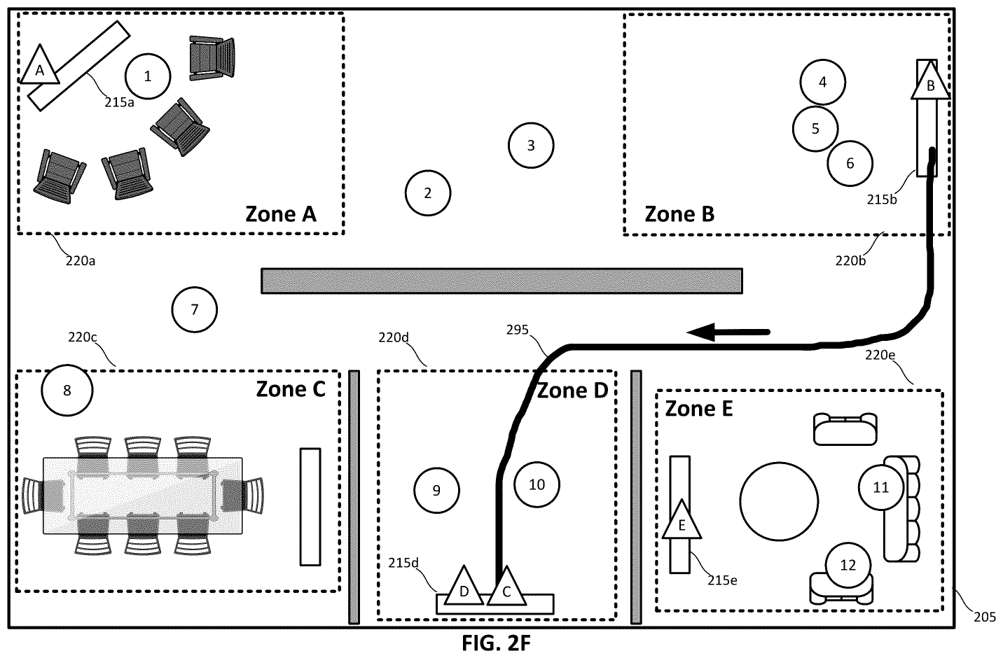

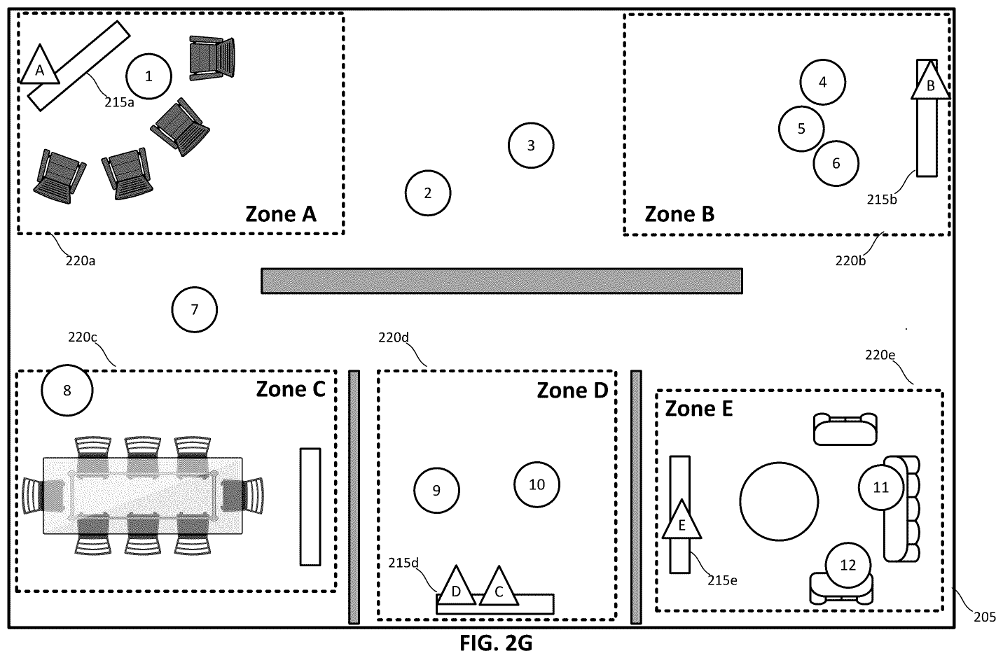

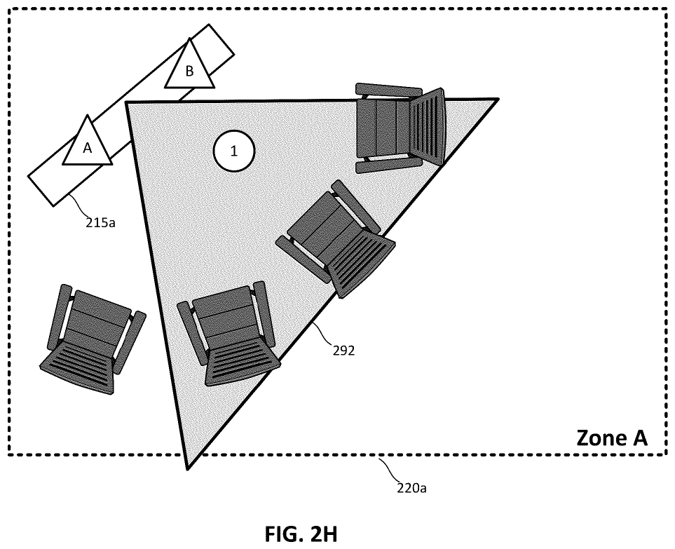

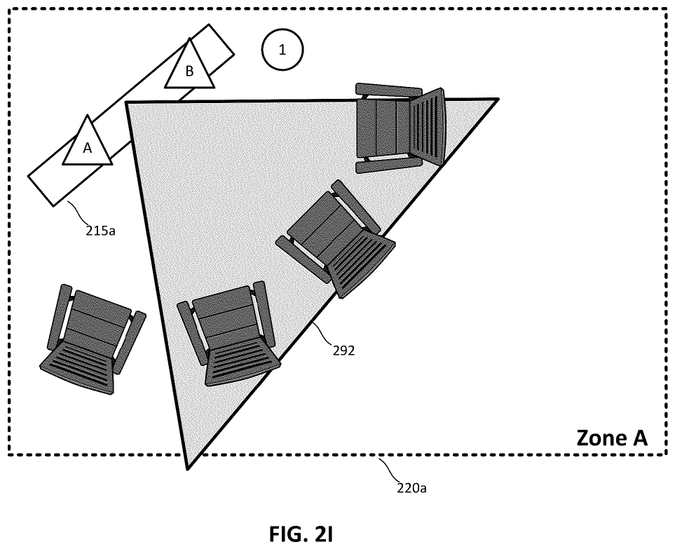

The portal support services 112 provide tools for setting up and managing group video calls. The portal support services 112 also provide tools for creating and/or uploading a skeuomorphic map of the physical spaces into which the communication portals 115a, 115b, and 115c are to be deployed. The map mimics the real-world layout of the venue in which the communication portals 115a, 115b, and 115c are deployed. The communication services platform 110 provides a map interface on the client devices 105a, 105b, and 105c of the remote users that provides the remote users with a sense of immersion and spatial awareness of the virtual location of the remote users within the physical space of a venue. The communication services platform 110 also provides a version of the map interface on the communication portals 115a, 115b, and 115c to provide the in-person users with location information for other virtual and in-person users. Examples of the map interface are shown in FIGS. 2A-2G and are discussed in detail in the examples which follow.

The identity management services 114 manages user authentication to determine whether a remote user should be permitted to access the services provided by the communication services platform 110. The portal configuration services 116 enable an administrator to set up communication portals, such as the communication portals 115a, 115b, and 115c to connect with the communication services platform 110 to provide a hybrid environment for interactions between remote and in-person users.

The client devices 105a, 105b, and 105c (collectively referred to as client device 105) may be used by remote users to connect with the communication services platform 110 to participate in a hybrid communication environment in which the remote users may interact with other remote users and in-person users. The client devices 105a, 105b, and 105c are each a computing device that may be implemented as a portable electronic device, such as a mobile phone, a tablet computer, a laptop computer, a portable digital assistant device, a portable game console, and/or other such devices. The client devices 105a, 105b, and 105c may also be implemented in computing devices having other form factors, such as a desktop computer, vehicle onboard computing system, a kiosk, a point-of-sale system, a video game console, and/or other types of computing devices. While the example implementation illustrated in FIG. 1 includes three client devices, other implementations may include a different number of client devices 105 that may utilize the communication services platform 110 to create and/or present presentation content. Furthermore, in some implementations, the application functionality provided by the communication services platform 110 is implemented by a native application installed on the client devices 105a, 105b, and 105c, and/or the communication portals 115a, 115b, and 115c.

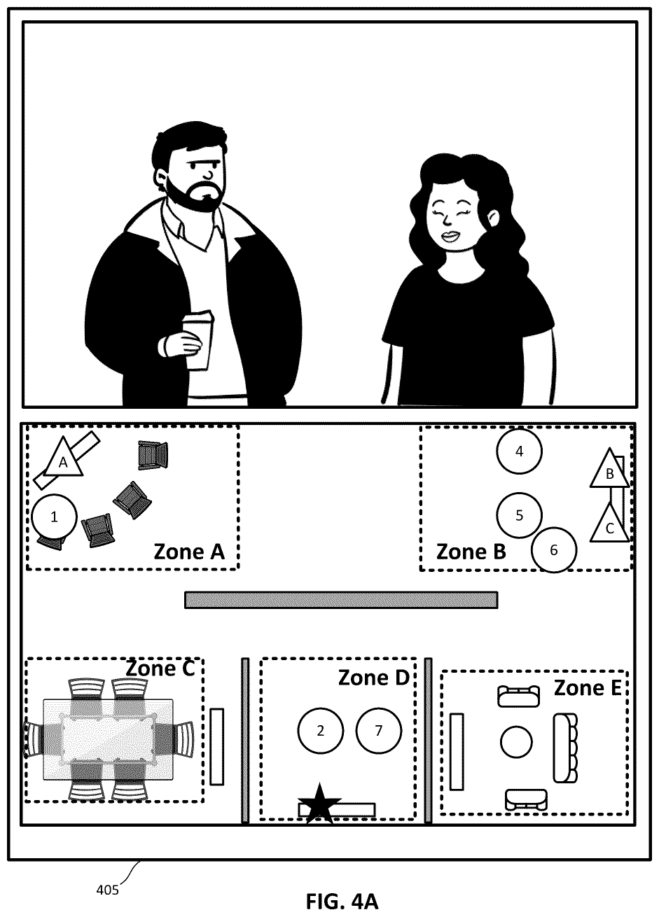

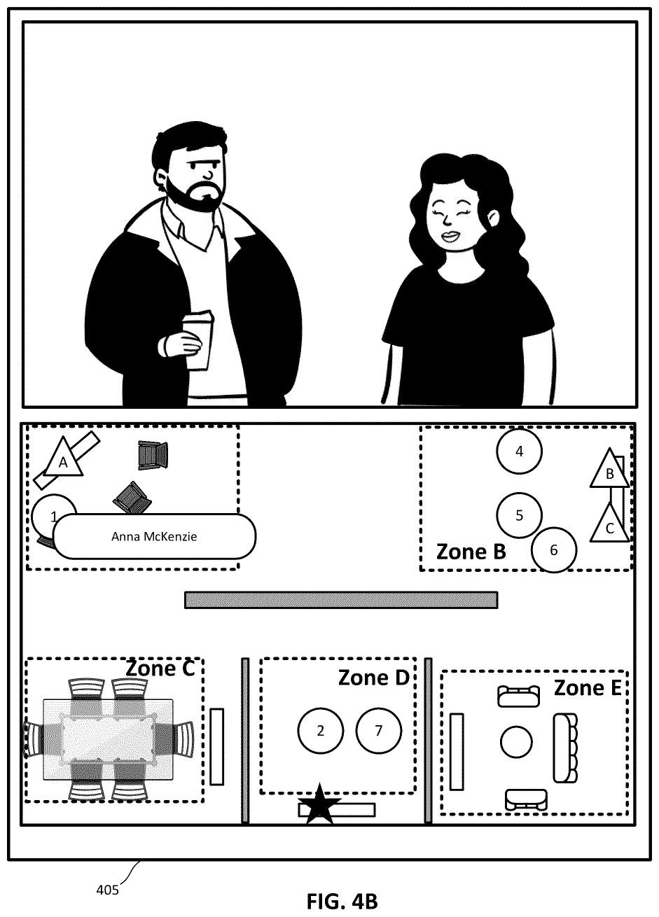

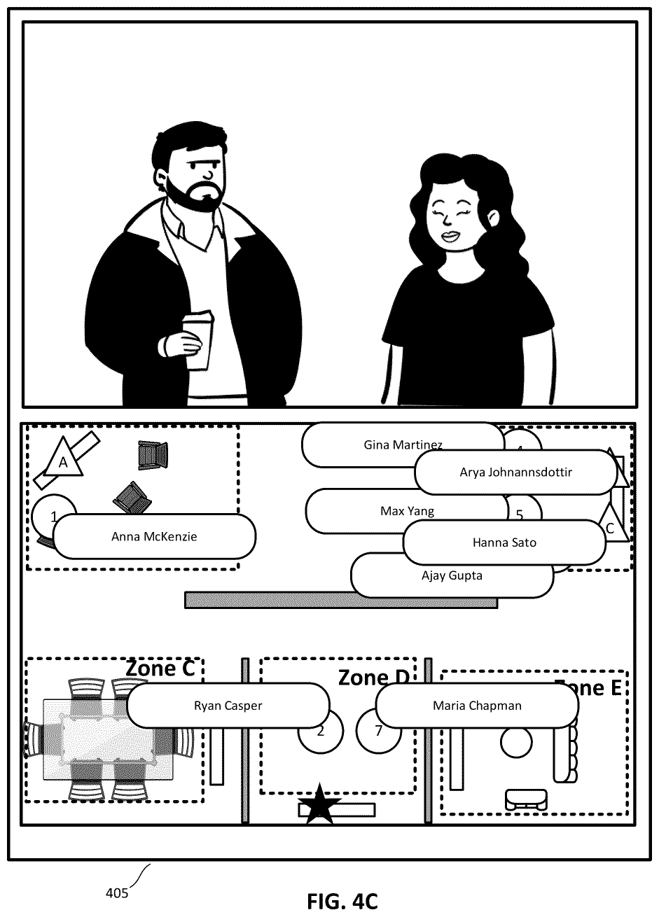

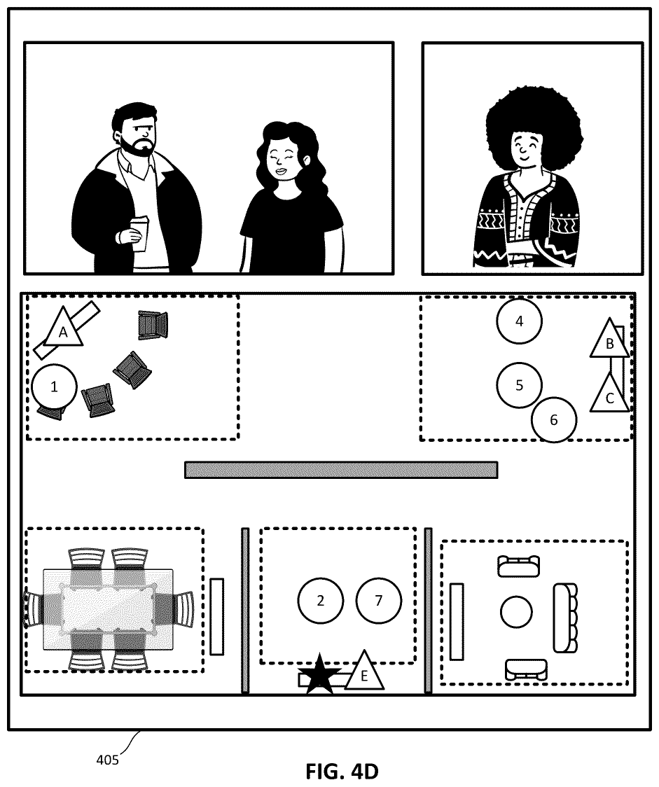

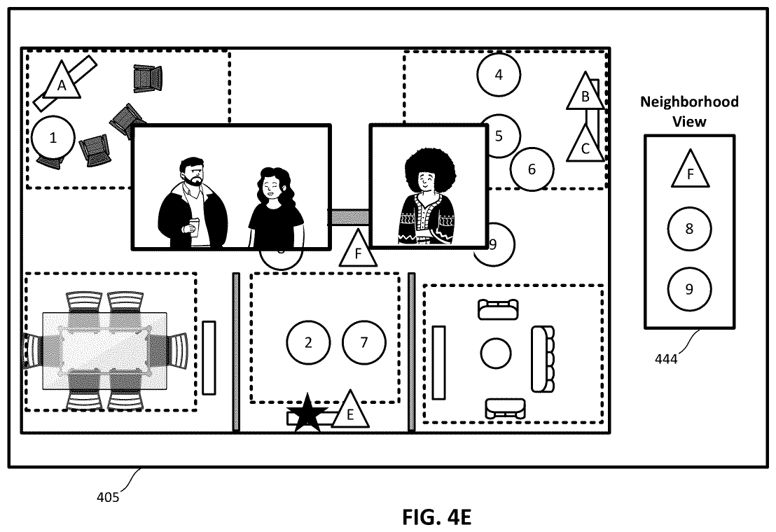

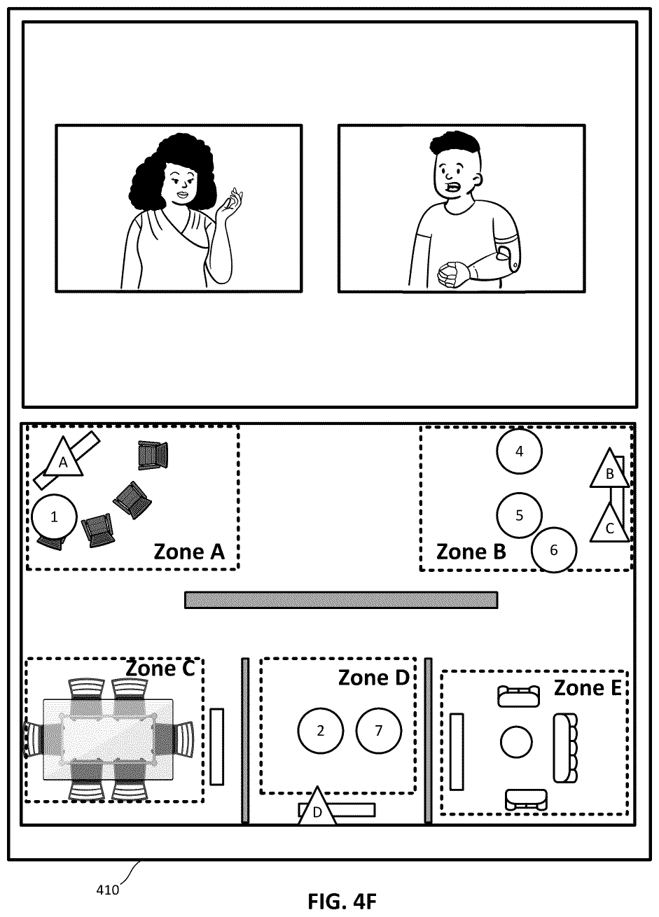

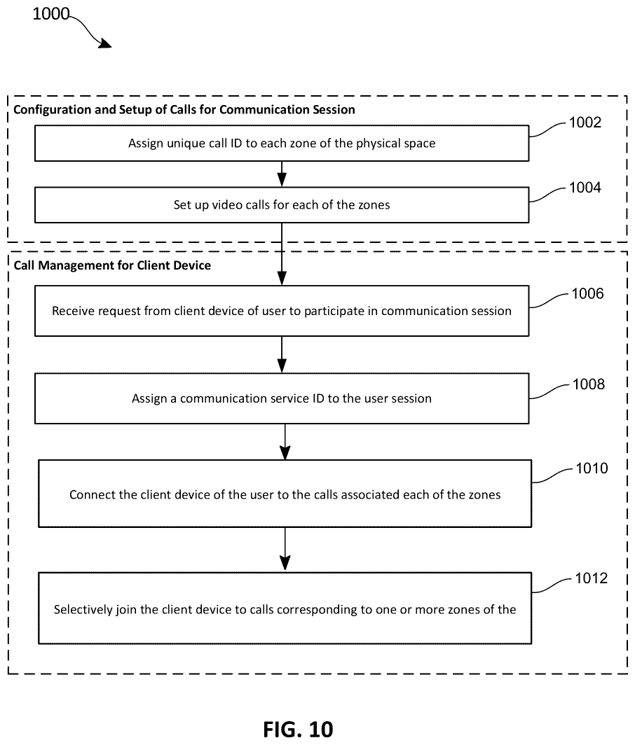

The client devices 105a, 105b, and 105c each include a client application 107a. 107b, and 107c, respectively which are referred to collectively as client application 107. The client application 107 is a native web-enabled application or web browser that communicates with the communication services platform 110 over a network connection to obtain the services provided by the communication services platform 110. These services include obtaining map and positional information for remote and in-person users from the communication services platform 110 and rendering a skeuomorphic representation of the space that represents a realistic layout of the space. Examples of such a user interface are shown in FIGS. 4A-4E and are discussed in detail in the example implementations which follow. The application 107 provides controls that enable the user to navigate through the representation of the physical space between the communication portals 115. The application 107 also provides a means for receiving a Uniform Resource Locator (URL) that enables the client device 105 to connect to the communications services platform 110 to participate in a particular communication session associated with a particular physical space. The URL may be provided to the remote users via an email, text message, notification message, or other means that enable the client devices 105a, 105b, and 105c to connect with a communication session. In other implementations, other techniques can be used to enable the client device 105 of the remote user to connect to the communication services platform 110. These techniques can include, but are not limited to, providing the user with a meeting identifier that the user may enter into a user interface of the client application 107, or a barcode or Quick Response (QR) code that the remote user can capture an image of using a camera of their client device. FIG. 10, which is discussed in detail below, provides an example workflow describing how the calls for a particular physical space can be set up by the communication services platform 110 and how the client device 105 of a user can be connected to the group video calls.

The communication portals 115a, 115b, and 115c are computing devices that include at least one large screen, at least one camera, and at least one microphone. The communication portals 115a. 115b, and 115c are disposed at different locations throughout a physical space in which an unstructured or semi-structured interactions between remote and in-person users is to be facilitated. The layout of the physical environment may differ in different implementations, and the number and location of the communication portals 115 may vary in different implementations. The communication services platform 110 supports multiple communication sessions with multiple sets of communication portals 115a, 115b, and 115c. FIGS. 2A-2H, which are described in detail in the examples which follow, provide additional details of how the communication portals 115a. 115b, and 115c may be disposed throughout a physical environment.

In some implementations, an administrator connects to the communication services platform 110 via a communication portal 115 and/or a client device 105 to set up a communication session for a physical space. In some implementations, the communication portals 115 are a part of a permanent or semi-permanent installation within the physical space in which the communication portals 115 remain in place, such as but not limited to an office space or a dedicated exhibition space for hosting conferences or other events. In other implementations, the communication portals 115 is temporarily installed in a physical space to host an event in which remote and in-person users may mingle. The administrator may upload and/or create maps of the physical space using tools provided by the communication services platform 110.

The communication services platform 110 provides tools that enable the administrator to generate an invitation email message, text message, or other type of message to invite remote users to participate in a hybrid communication session. The message may include a URL that enables the client device 105 of the user to connect with a particular communication session. The communication services platform 110 may also provide controls for the administrator to indicate how long a particular communication session is intended to last and whether the event is recurring or a one-time event. For limited time events, such as but not limited to a multi-day conference, the administrator may set up a recurring communication session that occurs for each of the days of the conference for a time period during which the conference events in which remote and in-person users are likely to intermingle using the communication portals 115 occur. In other implementations, such as an implementation for an office environment, the administrator may set up a recurring communication session that is active during typical workdays and times for those who are working in the office in-person when their remote colleagues are more likely to be able to communicate with and/or collaborate with their in-person colleagues.

The communication portals 115a, 115b, and 115c include a portal application 117a, 117b, and 117c (referred to herein collectively as portal application 117). The portal application 117 provides tools that enable an administrator to setup up the communication portal 115 to communicate with the communication services platform 110. The portal application 117 also provides tools for connecting with the communication portal 115 to set up a group call for the communication portal 115. The portal application 117 also is configured to send audio and video streams of the in-person users captured using the microphone and camera of the communication portal 115 to the communication services platform 110, and the communication services platform 110 sends these streams to the client devices 105 of the remote users. The portal application 117 also receives audio and video streams associated with the remote users that have navigated to the communication portal 115 and presents those streams on the speaker and display of the communication portal 115. The portal application 117 also displays the map interface shown in the examples which follow on the display of the communication portal 115. The portal application 117 receives map update information from the communication services platform 110 which provides updates to the locations of the remote and in-person users, and the portal application 117 updates the map interface presented on the display of the communication portal 115.

FIG. 10 is a flow chart of an example workflow 1000 for setting up the communication services platform 110.

The communication portals 115 are placed in the physical space in which the hybrid environment for interactions between the remote users and the in-person users are to be utilized. Once the communication portals 115 have been set up, each of the communication portals 115 (or the zone associated with the communication portal 115) is assigned a unique call ID in operation 1002. In some implementations, the unique call ID is set up using Microsoft Azure Communication Service (ACS). Other implementations the unique call ID is associated with each communication portal 115 using a different technique.

The communication services platform 110 initiates a group video call for each of the zones using the unique call IDs in operation 1004. The group video calls are set up prior to the event occurring in the physical space to enable the client devices 105 of the remote users to selectively join or leave the calls.

Once the communication session has been set up, the communication services platform 110 receives a request from the client device 105 of a remote user to participate in the communication session for the physical space in operation 1006. The communication services platform 110 facilitates remote users to join calls associated with the communication portals 115 on demand and without a per-class invitation link. Instead, the client devices 105 of the remote users can connect to the communication session associated with a particular physical space using an instance-specific URL as discussed in the preceding examples.

Each user is associated with a unique user identifier (referred to the communication services ID or “CSID” herein) in operation 1008. The user may log into the application 107 from their client device 105 using an application identity. This application identity may be mapped to the CSID by the communication services platform 110 internally. The CSID is generated by an authentication service. In some implementations, the authentication service is Microsoft Azure Active Directory® (AAD). The CSID is associated with an access token that permits the user to access the services provided by the communication services platform 110. The CSID is valid for the entire communication session. If the client device 105 of the user device disconnects from the communication session and reconnects while the communication session is ongoing.

The communication services platform 110 then connects the client device 105 of the user with the group video calls set up in operation 1004. In some implementations, the client device 105 is connected to all of the video calls that have been set up for the communication session. In other implementations, the communication services platform 110 and the client device 105 implement dynamic call management to reduce the demands on computing resources of the communication services platform 110 and the client device 105 as well as reduce the network resources associated with maintaining the client device 105 connections to the group video calls.

The dynamic call management implemented by the communication services platform 110 and the client device 105 selectively connects and disconnects the client device 105 from group video calls as the avatar moves through the virtual representation of the physical space. The dynamic call management connects the client device 105 with the group video call associated with the zone in which the user's avatar is located within the virtual representation of the physical environment and the group video calls of zones in the vicinity of the user's avatar. The zones in the vicinity are defined by two factors: (1) the porosity neighborhood, and (2) the speed at which the avatar is being navigated through the virtual representation of the physical environment compared with the time that it takes to connect the client device 105 of the user with a group video call. The porosity neighborhood refers to the zones around the location of the user's avatar from which the user is presented with sound at an attenuated level. The audio porosity and porosity settings are described in greater detail in the examples which follows. The speed and direction which the avatar is being navigated through the virtual representation of the physical environment, and the avatar's position relative a particular zone are used to determine whether the client device 105 should be connected to or disconnected from the group video call associated with that zone. The time required to connect or disconnect from the group video call can be multiplied by the speed at which the avatar is traveling to determine the trigger distance at which a call should be connected or disconnected. The dynamic call management provides several technical benefits, including reducing the startup delay when the client device 105 initially joins the communication session and reducing the computation and network resources required to support the client device 105 connections to the group video calls. Another technical benefit of this approach is that it permits the number of zones to be increased, thereby enabling the hybrid environment provided herein to be extended to larger physical spaces having a greater number of zones.

FIGS. 2A-2H are examples of a map interface that may be implemented by the communication services platform 110 shown in FIG. 1. FIG. 2A shows an example of a user interface 205 that presents a skeuomorphic map of a physical space in which a hybrid communication session is being set up for an event that allows remote and in-person users to intermingle in one of five zones 220a, 220b, 220c, 220d, and 220e. Each zone includes a respective communication portal 215a. 215b, 215c, 215d, and 215e, which are similar to the communication portals 115 shown in FIG. 1. Each communication portal 215a, 215b, 215c, 215d, and 215e includes a large display screen for presenting video streams and a speaker for outputting audio streams of any remote users who have navigated to a particular zone. The respective client devices 105 of the remote users capture these audio and video streams, send the streams to the communication services platform 110, and the communication services platform 110 sends these streams to the respective communication portal 215a, 215b, 215c, 215d, and 215e to which the remote users have navigated. The respective communication portal 215a, 215b, 215c. 215d, and 215e include a camera for capturing video streams and a microphone for capturing audio streams of the in-person users who are present in the respective zone associated with the communication portal. The map closely mimics the layout of the physical space to provide the remote users with an improved sense of spatial orientation within the physical space. The map interface 205 is presented to the remote users on a display of their client devices 105, as shown in FIGS. 4A-4E and is also presented to the in-person users on a display of the communication portals 115 as shown in FIG. 4F.

As will be discussed in greater detail in the examples which follow, each of the communication portal 215a, 215b, 215c, 215d, and 215e is associated with a respective group video call that is facilitated by the communication services platform 110. The communication portal 215a, 215b, 215c, 215d, and 215e are set up at their respective locations within the physical environment and each communication portal 215a, 215b, 215c, 215d, and 215e contacts the communication services platform 110 to establish the group video call for that communication portal. The communication services platform 110 facilitates transitioning of a remote user from a first group video call associated with a first zone of the physical location to a second group video call associated with the second zone of the physical location. The transition process is handled automatically by the communication services platform 110 and the client device 105 of the remote user. The remote user does not need to be aware of or take any action in order to initiate the transition. In a conventional teleconferencing system, the remote user would need to manually disconnect the client device 105 of the remote user from the first group call, obtain an invite to the second group call, and establish a connection to the second group call from their client device 105. The communication services platform 110 automatically facilitates a seamless transition of the client device 105 of the remote user without the user being aware of or having to take any action beyond navigating to a different zone within the physical environment. Consequently, the sense of immersion and spatial awareness of the remote users is significantly improved because the remote users are able to navigate through a representation of the physical location to participate in different conversations in a similar manner as the in-person users. Another technical benefit of the communication services platform 110 managing the multitude of group video calls is that the communication services platform 110 can provide for audio porosity between conversations. Current teleconferencing platforms provide closed environments in which the audiovisual content of the call is only available to the participants of the call. However, this approach would isolate the remote users from hearing the conversations that are going on in nearby zones as they traverse the representation of the physical environment. The techniques herein provide a technical solution for this problem by determining the location of the remote user within the representation of the physical environment and provide attenuated audio from nearby zone or zones that fall within a threshold distance from the location of the remote user.

FIG. 2B shows an example of the user interface 205 in which the remote users, are represented by triangular icons (also referred to herein as avatars), and in-person users, are represented by circular icons (also referred to herein as avatars). In the example implementation shown in FIG. 2B, the icons representing the remote user and the in-person users are numbered to help distinguish between the individual users. In some implementations, the icons representing the remote users and the in-person users include an image of the user, an image of an avatar representing the user, a name of the user, initials of the user, and/or other information that identifies the users to other remote and in-person users. In some implementation, as will be discussed in the examples which follow, a user may click on, touch, or otherwise activate an icon associated with another user to cause the map interface 205 to present additional information about the user associated with the icon that has been activated. Furthermore, while shapes are being used to distinguish between the icons of the remote user and the in-person users, other techniques such as but not limited to different colors may be used for the icons associated with remote and in-person users.

The in-person users can navigate freely throughout the physical environment. The communication services platform 110 simulates this experience for the remote users by enabling the remote users to navigate among the communication portals 115. Examples of this navigation are provided in the examples which follow. The in-person users and the remote users are visible to one another within the same zone. For example, the in-person users 4, 5, and 6 and the remote users B and C would be seen and heard by one another via the communication portal 215b. As will be discussed in greater detail in the examples which follow, the remote users may also overhear an attenuated version of the conversations from nearby zones based on their audio porosity settings. In some implementations, the remote user may overhear nearby conversations as the remote user navigates among the communication portals 215 within different zones of the physical space and/or from nearby zones within the physical environment while participating in a conversation within a particular zone of the physical space.

FIG. 2C-2G show an example of the user interface 205 in which the remote user C is navigating from the zone 220b to zone 220d. In order to establish a sense of presence and to reinforce spatial awareness, the remote users cannot simply teleport among the communication portals. Instead, the remote users are subjected to similar constraints of the physical space as an in-person user. The remote users cannot navigate through walls, furniture, fixtures, or other obstructions in the physical environment. These obstructions can be identified by an administrator when the map of the physical environment is being created or the communication services platform 110 may automatically identify such features by analyzing the map image using a machine learning model trained to identify such obstructions. The communication services platform 110 also limits the speed of movement of the remote user to a speed that is akin to that of an average in-person user traversing a similar path through the physical environment. Such calibration could be achieved automatically. Such constraints are used to ensure surprise-free interactions with other users within the environment. A first virtual or in-person user can be assured that a second virtual or in-person user who is located at the other end of the physical space will take time to traverse from that end of the physical space and will not suddenly appear next to the first user. Thus, the second user will not be immediately within earshot of a conversion in which the first user is participating, and the first user can calibrate their discussion accordingly as the second users approaches. The progress of the second user can be monitored on the map interface and/or call panel of the first user's client device 105 for remote users or via the map interface of the communication portals 215 when the first user is an in-person user who is physically present in the physical space. In other implementations, the communication services platform 110 can implement a systematic delay for incoming users to join a conversation at a communication portal 115 and aural and/or visual indication of the incoming user joining the conversation. For example, the communication portal 115 may provide an audio chime indicating that a user is about to join the conversation and/or present the avatar of the incoming user.

In the example implementations shown in FIGS. 2C-2F, the user navigates a path 295 from the zone 220b to zone 220d. In some implementations, the client device 105 includes a touchscreen interface and the remote user may draw the path 295 using their finger or a stylus. In other implementations, the client device 105 include a mouse, touchpad, or other such input devices that enables the user to navigate along the path 295. While the example shown in FIG. 2C shows the path 295 connecting the communication portals 215b and 215d, the communication services platform 110 is configured to permit the path 295 to begin anywhere within a first zone and to end anywhere within a second zone to trigger the navigation of the remote user from the first zone to the second zone. The path 295 is only visible on the map interface 205 on the client device 105 of the remote user that has drawn the path. In yet other implementations, the user may utilize a game pad, joystick, keyboard, or other type of controller to manually navigate the remote user along a path through the representation of the physical space without requiring the remote user to draw the path on the map interface 205.

FIG. 2D shows the remote user C traveling along the path between the zone 220b and the zone 220d. As the remote user C passes zone 220e, referred to as “Zone E” on the map interface, the remote user C can overhear the conversations that are taking place in Zone E at an attenuated level due to the audio porosity provided by the communication services platform 110. The remote user E and the in-person users 11 and 12 in Zone E can see on the map interface 205 that remote user C is passing by Zone E and may be able to overhear the conversation taking place therein depending upon the audio porosity settings of the remote user C. The attenuation of the volume of the audio content can be determined based on the distance of the avatar representing the user is from a particular zone. The attenuation may also be based in part on the presence of one or more obstructions between the location of the avatar representing the user within the virtual representation of the physical space and the zone. Other factors, such as the audio porosity setting selected by the user may also considered by the communication services platform 110 how much to attenuate the volume of the audio from the nearby zones. The user may specify a distance at which the conversations are no longer heard and/or a maximum volume level that the audio content from the nearby zones may be played back on the client device of the user. Depending upon the location of the user's avatar within the virtual representation of the physical space, the user may be able to hear attenuated audio from more than one communication portals 115 of multiple zones. In some implementations, the user is presented with an audio porosity slider that the user can use to increase or decrease the audio porosity, including turning off audio porosity completely for that user. A technical benefit of this approach is that the remote user may customize the audio porosity setting to best suit their needs and to improve their user experience. Some users may prefer to be able to overhear conversations taking place further away to provide them an opportunity to identify potentially interesting conversations that the user would like to join, while other users may find that overhearing conversations taking place further away are distracting and reduces the audio porosity for their client device 105.

FIG. 2E shows the remote user C continuing to approach the zone 220d. The communication services platform 110 further attenuates the audio from Zone E as the remote user C moves away from Zone E and closer to Zone D. The communication services platform 110 then provides attenuated audio content from Zone D as the remote user C approaches Zone D. The map interface 205 alerts the remote user D and the in-person users 9 and 10 that the remote user C is approaching Zone D. FIG. 2F shows the remoter user C having navigated to the communication portal 215d in Zone D. FIG. 2G shows the map interface 205 after the remote user C reached their destination in Zone D and the path 295 is no longer displayed. The communication services platform 110 facilitates stopping the video feed of remote user C presented at the communication portal 115b of Zone B as well as to any remote users connected to communication portal 115 as the remote user C navigates beyond the boundary of Zone B. The communication services platform 110 also stops the video feed of the other remote and in-person users at Zone B presented on the client device 105 of the remote user C. However, the audio feed from the communication portal 115b of Zone B continues to be provided to the client device 105 of the remote user C according to the call porosity settings. Furthermore, as the remote user C navigates into Zone D, the communication services platform 110 provides the video feed of the other remote and/or in-person users at Zone D to the client device 105 of the remote user C. The communication services platform 110 also provides the video feed from the client device 105 of the remote user C to the communication portal 215d and to the client devices 105 of the remote users at Zone D as the remote user C navigates within the boundary of Zone D. The audio feed from the communication portal 115d is provided to the client device 105 of the remote user C as the remote user C navigates toward the boundary of Zone D according to the call porosity settings. The communication services platform 115 provides the audio from the client device 105 of the remote user C to the communication portal 215d and to the client devices 105 of any remote users once the remote user C has navigated within the boundary of the Zone D. In the example implementation shown in FIG. 2E, the communication services platform 110 then causes the video stream of the remote user C to be presented on the display of the communication portal 215d and the audio stream received from the client device 105 of the remote user C to be included in the audio output of the speaker of the communication portal 215d so that the in-person users 9 and 10 can see and interact with the remote user C. Furthermore, the remote user D can also see and hear the remote user C on the user interface of their client application 107.

FIGS. 2H and 2I show a portion of the map from FIGS. 2A-2G to illustrate another aspect of the functionality provided by the communication services platform 110. The communication services platform 110 provides adaptive muting of the communication portals, such as the communication portal 215a shown in FIGS. 2H and 2I. The communication portal 215a includes a camera that has a limited field of view (FOV) 292 which creates blind spots within Zone A. In FIG. 2H, the in-person user 1 is within the FOV 292 of the camera of the communication portal 215a, while in FIG. 2I the in-person user 1 is outside the FOV 292 of the camera of the communication portal 215a. The microphone and the speaker of the communication portal 215a are muted when no in-person users are detected within the FOV 292 of the camera of the communication portal 215a. In some implementations, the communication portal is configured to implement a presence detection model that analyzes video captured by the camera of the communication portal and outputs a signal indicating whether an in-person user has been detected within the FOV 292 of the camera, and the communication portal selectively mutes or unmutes the microphone and speaker based whether at least one in-person user is present. In other implementations, the communication services platform 110 analyzes the video stream from the communication portal to determine whether anyone is present and sends a control signal to the communication portal to enable or disable the microphone and speaker. A technical benefit of this approach is that an unseen in-person user who is outside of the field of view of the camera cannot intentionally or inadvertently overhear the conversation among remote users who are present at the communication portal. Similarly, remote users at the communication portal cannot inadvertently or intentionally overhear the conversation among in-person users who are outside of the FOV 292 of the camera and may not be aware that any remote users could overhear their conversation. Turning off the microphone and the speaker at the communication portal ensures that the conversations remain private in this situation. Any remote users who have navigated to the communication portal can continue to converse among themselves. Should an in-person user later appear within the FOV 292 of the camera, the map interface and the video stream from the communication portal provide sufficient notice to the remote users that an in-person user is present and may be able to overhear their conversation. In some implementations, the communication services platform 110 provides tools that enable an administrator to configure the behavior of the communication portals 215 based on the presence of any in-person and/or remote users at a particular communication portal 215. A technical benefit of this approach is that the administrator is provided with a set of flexible tools that allow the administrator to configure the behavior of the communication portals 215.

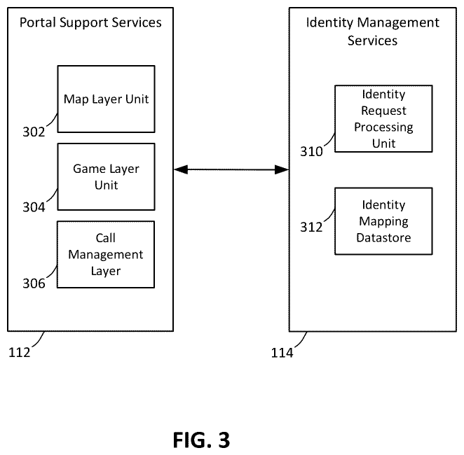

FIG. 3 shows additional details of the portal support services 112 and the identity management services 114 of the communication services platform 110. The call support services 112 include a map layer 302, a game layer 304, and a call management layer 306. The identity management services 114 include an identity request processing unit 310 and an identity mapping datastore 312.

The map layer 302 is configured to provide tools that enable an administrator to define the map associated with a physical space. The map is a skeuomorphic representation of the physical space that provides both the remote and in-person users with a reference of the layout, dimensions, and appearance of the physical space to prompt spatial awareness. The map layer 302 provides tools for manually creating a layout of the physical space using drafting tools and/or tools that are configured to analyze photographs of the physical space to generate the map in some implementations.

The game layer 304 implements a game engine that enables the remote user to navigate the virtual representation of the physical location created using the map layer 302. In some implementations, the game layer 304 implements an HTML 5 based game engine, such as but not limited to Phaser 3 game engine. The game layer 304 provides navigation tools that enable the remote users to navigate through the virtual representation of the physical location using various inputs as discussed in the preceding examples. The game layer 304 tracks movement of in-person users through the physical space and movement of the remote users through the virtual representation of the physical space. The movement of the remote users is tracked based on the navigation signals input by the remote users via their respective client devices. As discussed in the preceding examples, the user may use a keyboard, mouse, touchpad, touchscreen, or other input device to provide inputs to navigate through the virtual representation of the physical space. The movement of the in-person users may be tracked by using face detection and matching on the cameras of the communication portals placed throughout the physical space. The in-person users may check in at a kiosk or one of the communication portals and the kiosk or communication portal captures an image or images of the in-person user to use for tracking the movement of the user through the physical space. For privacy purposes, the communication services platform 110 performs face detection rather than face recognition in some implementations. The communication services platform 110 merely detects that an in-person user having detected facial characteristics is located at a particular location within the physical space and can track the location of that user throughout the physical space. In some implementations, an avatar of the user with based on the image captured may be presented on the map interface, to enable other remote and in-person users to locate the user within the physical environment. However, the communication services platform 110 does not, however, attempt to identify who the in-person user is using facial recognition techniques or to associate or store any biometric information for the in-person users. The images captured are merely for the purposes of supporting the map interface during an event. In other implementations, the communication services platform 110 implements facial recognition. In such implementations, facial recognition is provided to provide reciprocity between the remote users and the in-person users so that the remote users are provided with an indication of the identity of the in-person users present in the physical space. The in-person users are provided an indication of the identity of the remote users on the user interface of the remote portals 215. The communication services platform 110 provides controls that enable an administrator to configure when facial recognition may be used for a particular communication session. In some implementations, the use of facial recognition can help identify remote and/or in-person users with whom a particular user may wish to engage during the communication session based on social graph information of the user and/or other users. The social graph information for a user is based on the user's contacts, other users whom the user has recently contacted via email, messaging, social media, or other platforms, subject matter that the user typically works or for which the conducts searches, and/or other such information may be used to identify other remote and/or in-person users with whom a user may wish to engage during the communication session. The communication services platform 110 provides tools for obtain consent from user where facial recognition is used in some implementations. In such implementations, a user may be permitted to opt out of the use of facial recognition for a particular communication session based on the settings configured for that communication session by an administrator. In some instances, the user may not be provided with an option to opt out. For example, the administrator for an enterprise or other organization in which the systems described herein are being utilized may not provide an opt out for users, because the users are expected to all be part of the enterprise or organization and facial recognition is utilized to facilitate reciprocity among the remote and in-person users.

The call management layer 306 implements the call connection logic that facilitates which calls the client device 105 of a remote user may actively or passively participate in as the remote user navigates through the virtual representation of the physical location. As discussed in the preceding examples, the client device 105 of the remote user is connected to all of the group video calls associated with a communication session in some implementations. However, the call management layer 306 also implements dynamic call management in some implementations to selectively connect or disconnect the client device 105 of the remote user from the group video calls as they navigate through the virtual representation of the physical environment.

The call management layer 306 can selectively activate or deactivate the call audio and/or video portion of the group video call for a particular client device 105 of a remote user to enable the remote user to actively or passively participate in group video calls. The call management layer 306 activates the audio and video portion of a group video call in response to the user navigating their avatar into the zone associated with the group video call. This allows the client device 105 of the remote user to provide audio and video input that is presented on the communication portal 115 associated with the zone into which the user has navigated. The call management layer 306 deactivates the audio and video input from the group video call from the client device 105 of the remote user as the remote user navigates away from a zone. The call management layer 306 mutes the audio input from the client device 105 of the remote user and halts the video stream so that remaining participants to the group call can no longer hear or see the user. The remote user is no longer presented as an active call on the call panel of the communication portal 115 associated with the zone, and the user interface of the client device 105 no longer shows the calls associated with the remote and/or in-person users associated with the group video call. The call management layer 306 does maintain the audio connection from the group video call associated with the zone from which the remote user has navigated based on the call porosity settings, so the remote user will continue to hear the conversations from that zone until the user navigates beyond the audio porosity threshold but the other users participating in the group video call will not be able to hear the remote user. When the remote user navigates into a new zone, the call management layer 306 activates the audio and video from the client device 105 of the remote user so that the remote user can actively participate in the group video call.

The call management layer 306 also handles creating composite audio and/or video streams for each of the client devices 105 of the remote users and for the communication portals in some implementations and streams the composite audio and/or video streams to the respective devices. The contents of these streams may vary depending upon recipient device.

In some implementations, the call management layer 306 implements the audio porosity for a remote user as follows. The call management layer 306 monitors the location of the remote user based on location information obtained from the game layer 304. The call management layer 306 determines whether the remote user exits a zone in which a communication portal is located, such as those shown in FIGS. 2A-2G, the volume of the audio emanating from that zone, as received by the client of the user who just exited, is automatically decreased. Thus, the call management layer 306 controls the attenuation of the call volume on a per user basis as the remote users move throughout the environment. The call management layer 306 reduces the volume of the audio stream being provided to the client device 105 automatically. In some implementations, the volume is automatically reduced to a default attenuated volume. In a non-limiting example, this default attenuated volume is 15% of the volume of the sound captured by the microphone of the communication portal located in that zone. In some implementations, the communication services platform 110 provides controls that enable the remote users to override this default value with a custom value that suites the user preferences. Some users may find the default threshold too low, while other remote users may find the default threshold is too high. The call management layer continues to further reduce the volume of the sound emanating from the zone that the user is leaving as the user moves further away from this zone. Zones that are farther from the location of the remote user thus contribute less to the audio stream provided to the client device of the remote user. Consequently, the remote users are not overwhelmed by audio emanating from zones that are farther from the remote user.

As the user navigates through the virtual representation of the physical space, the user may be able to overhear conversations from multiple zones depending upon their location. The call management layer 306 determines a normalized distance from each zone's center. For a respective zone/the center of the normalized distance di from the center of the zone is determined by

$$\\ \frac{distance of the remote user ' s avatar from zone i}{max\_distance} ,$$

where max_distance refers to the greatest possible distance within the physical environment that the user's avatar can be from the zone. In some implementations, the call management layer 306 utilizes a background threshold distance to determine the maximum distance that a zone may be from the position of the user's avatar and still contribute to the audio provided to the remote user. In some implementations, the background threshold distance is determined based on a radius of a circle centered on the location of the avatar of the user that encompasses the center points of a threshold number of zones proximate to the location of the remote user's avatar. In some implementations, this threshold number is set to four zones, because some users find that including audio content from more than this number of zones becomes distracting.

The call management layer 306 implements reciprocity requirements on the remote users. The remote users must both turn on the camera of their client device 105 and be in view of the camera. To ensure that the latter requirement is met, the call management layer 306 implements a liveliness detection on the video stream from the client device 105 of the remote user. The liveliness detector of the call management layer 306 implements a face detector, a face-spoofing detector, an eye-mouth movement detector, or a combination of two or more of these detectors. In some implementations, the face spoofing detector extracts histograms from the video stream from the client device 105 of the remote user that corresponds to the YcbCr and the CIE L*u*v* color spaces and uses an ExtraTreesClassifier to analyze the color space information to distinguish genuine face samples from a spoofing attack. A user may attempt to defeat the face-spoofing detector by sending a genuine face sample through a virtual camera device. The eye-mouth movement detector determines whether the eyes and mouth of the user are moving in the video stream from the client device 105, which can be used to defeat attempts to use a static image of the remote user to defeat the reciprocity requirements. In some implementations, the eye-mouth movement detector implements a challenge-response model that prompts the user to perform some action, such as looking up, to the right, to the left, smile, open their mouth, frown, and/or other such motions and determines whether the user has provided an appropriate response to the challenge. This approach can be used to detect attempts to thwart the reciprocity requirements by providing a prerecorded video clip of the remote user. The call management layer 306 refuses to connect the client device 105 of the remote user to a group video call of one of the communication portals 115 if the user is not detected in the video stream. Furthermore, the user device 105 of a remote user can be disconnected if the remote user no longer appears to be present after the client device 105 of the remote user has been connected to the group video call. The call management layer 306 is configured to automatically connect the remote users to a default communication portal 115 that serves as an entry point into the representation of the physical location in some implementations, and then the remote users may navigate to other communication portals 115.

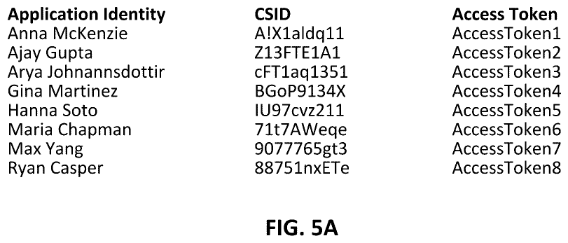

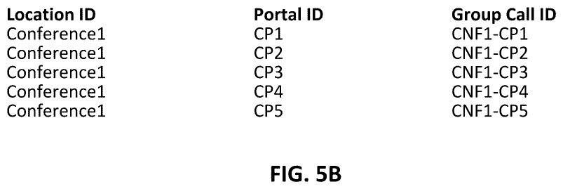

The identity management service 114 determines whether the client device 105 of a particular remote user should be permitted to access the group video calls associated with a particular physical location. As discussed in the preceding examples, the communication services platform 110 provides a URL to the client device 105 of the remote users that enables the client device 105 to connect to the communication services platform 110 using the web-enabled application 107 or a web-browser. The web-enabled application 107 or web-browser uses the URL to establish a connection to a particular communication session associated with a particular physical location that permits the remote user to navigate among the communication portals present at that physical location during the communication session. The client device 105 can authenticate the user using an application identity. This application identity is mapped to a communication services identity. This mapping is performed prior to the URL being provided to the remote user. This mapping is established during an enrollment process in some implementations, which collects information used to map the application identity with a communication services identity utilized by the communication services platform 110. The identity mapping datastore 312 is used to store this mapping information. In some implementations, this mapping can be stored in the mapping datastore 312 using a data structure similar to that shown in FIG. 5A. This data structure associates the application identity that the remote users uses to log into the application 107 from their client device 105. The application identity is associated with a particular communication services identity by the communication services platform 110. This mapping is used to obtain the access token used to permit the user to access the services provided by the communication services platform 110. The client device 105 provides this access token to the communication services platform 110 in order to access these services.

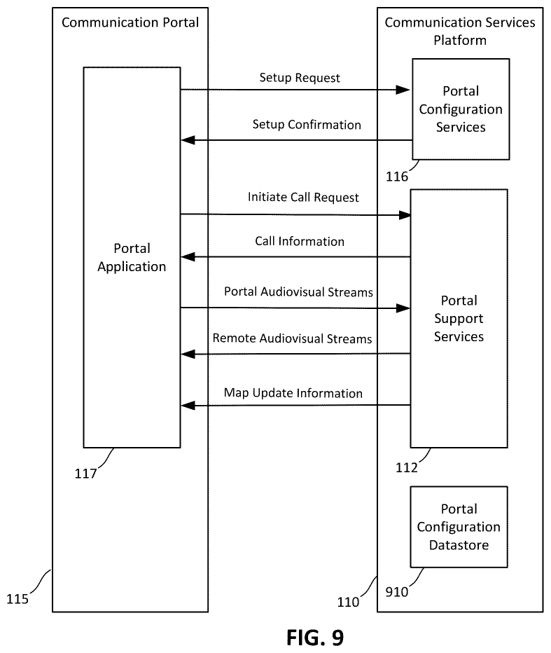

FIG. 9 is a diagram that shows the interactions between a communication portal 115 and the communication services platform 110 when configuring the communication portal 115 to operate with the communication services platform 110 and when operating the communication portal 115. Once the communication portal 115 has been installed either permanently or temporarily at a specified location within the physical space, the portal application 117 of the communication portal 115 sends a setup request to the communication services platform 110. In some implementations, the setup request includes a network address of the communication portal 115, a physical location of the communication portal 115, and/or other information that may be used to configure the communication portal. The portal configuration service 116 stores the communication portal information in a portal information data structure, such as that shown in FIG. 5B, in some implementations. The portal configuration data structure includes a location identifier associated with the physical space in which the communication portal 115 has been installed, a portal identifier associated with the communication portal 115, and a group call identifier which is used to store an identifier of the group video call associated with the communication portal 115. The portal configuration services 116 stores the portal configuration data structure in the portal configuration datastore 910, which is a persistent datastore in a memory of the communication services platform 110 that is used to store information associated with the communication portals 115 supported by the communication services platform 110.

Once the portal has been configured to operate with the communication services platform 110, the portal application 117 sends an initiate call request to the portal support services 112 of the communication services platform 110 to setup the group video call to support remote users that navigate to the communication portal 115. The portal support service 112 sets up a group video call for the communication portal 115 and updates the portal configuration data structure with the group call ID associated with the group video call. The portal support services 112 provides call information to the communication portal 115 in response to setting up the group video call. The call information may include the group call ID and/or other information associated with the group video call. Once the group video call has been set up, the communication portal 115 can begin sending audio and video streams of the physical space captured by the communication portal 115 to the communication services platform 110. These audio and video streams enable remote users to see and hear the in-person users who are located at the physical space. The portal support services 112 can then connect remote users that navigate to the communication portal 115 to the group video call associated with the communication portal 115. The portal support services 112 send remote audiovisual streams based on the content received from the client devices 105 of the remote users to the communication portal 115 so that the in-person users can see and hear the remote users. In some implementations, the portal support services 112 sends the streams received from the client devices 105 of the remote users to the communication portal 115. The portal support service 112 aggregates and/or performs other processing on the audio and video streams received from the client devices 105 before sending the streams to the communication portal 115. In some implementations, the audio and video content may also be aggregated into a single stream by the client devices 105 and/or by the portal support services 112.

The portal support services 112 also provides map update information to the communication portal 115. The map update information provides updated location information for the in-person and remote users. The portal application 117 updates the map presented on the display of the communication portal 115 using this information so that the map interface provides substantially real-time information regarding the position of the in-person and remote users.

FIGS. 4A-4F are diagrams of example user interfaces of a communication application that incorporates the techniques provided herein to provide a hybrid environment for interactions between remote and in-person users. FIGS. 4A-4E shows an example of a user interface 405 that is presented by the application 107 of the client device 105 of a remote user. FIG. 4F shows an example of a user interface 410 that is presented on a display of the communication portal 115.

FIG. 4A shows an example of the user interface 405 presented on the client device 105 of a remote user. The user interface 405 includes a map pane which presents a version of the map of the physical location shown in FIGS. 2A-2G. The location of the remote user is represented as a star-shaped icon, which indicates that the remote user has navigated to the communication portal 115 shown in Zone D at the bottom center of the map pane. The user interface 405 also includes a location view pane that presents a view of Zone D of the physical location associated with the communication portal 115. The location view pane allows the remote user to see the in-person users who are within the FOV of the camera of the communication portal 115. In the example shown in FIG. 4A, the in-person users 2 and 7 are present in Zone D.

FIG. 4B shows an example of the user interface 405 in which the user has touched, clicked on, or otherwise activated the icon associated with the in-person user 1 in Zone A. The user interface 405 presents additional information about the selected user. In this example, the user's name is presented, but other information such as photo of the user, business information for a user, contact information for the user, and/or other information associated with the user may be presented in response to activating the icon associated with the user.

FIG. 4C shows another example of the user interface 405 in which the user has entered a command to cause the user interface 405 to present additional information for all of the virtual and in-person users who are currently present. This approach can provide information for all of the users present so that a virtual or in-person user can quickly identify the location of another user with whom they would like to speak and to navigate to that location.

FIG. 4D shows another example of the user interface 405 in which a remote user is interacting with two in-person users (users 2 and 7) and a remote user (user E). The user interface 405 includes the video stream received from the client device 105 of user E so that the remote user can see both the in-person users and the remote users with whom the remote user is interacting. The remote user may interact with multiple remote users, and in such instances, the video stream from the client devices 105 of each of the remote users would be presented on the user interface. In some implementations, the video stream captured by the communication portal is presented even if no in-person users are present. In other implementations, the video stream captured by the communication portal is hidden if no in-person users are present, and the video stream is presented on the user interface 405 in response to the presence of an in-person user being detected in the field of view of the camera of the communication portal.

FIG. 4E shows another example of the user interface 405 which is similar to that shown in FIG. 4D, except the video of the in-person users and the remote user are overlaid on the map. In such implementations, the video overlaid onto the map may obscure details of the remote and/or in-person users who are nearby. To address this issue, a neighborhood view pane 444 has been added to the user interface 405 that shows the avatars of nearby remote and/or in-person users. In some implementations, the size of the avatars in the neighborhood view pane 444 is adjusted according to how far the remote or in-person user is from the zone in which the conversation show in the video is associated.

FIG. 4F is an example of a user interface 410 that is presented on the display of the communication portal 115, in some implementations. The user interface 410 includes the map of the physical environment discussed in the preceding examples. The map provides the in-person users with an overview of the physical location in which they are present and information indicating the locations of the remote and in-person users. In the example shown in FIG. 4F, the user interface 410 shown represents the communication portal 115 located in Zone B. The upper portion of the user interface provides a video feed of the remote users (users B and C). The user interface 410 may include additional information about each of the remote users, such as but not limited to their name, location, contact information, and/or other information associated with the remote users. The communication services platform 110 provides privacy controls in some implementations that enable both the remote and in-person users to configure which information is presented for each user.

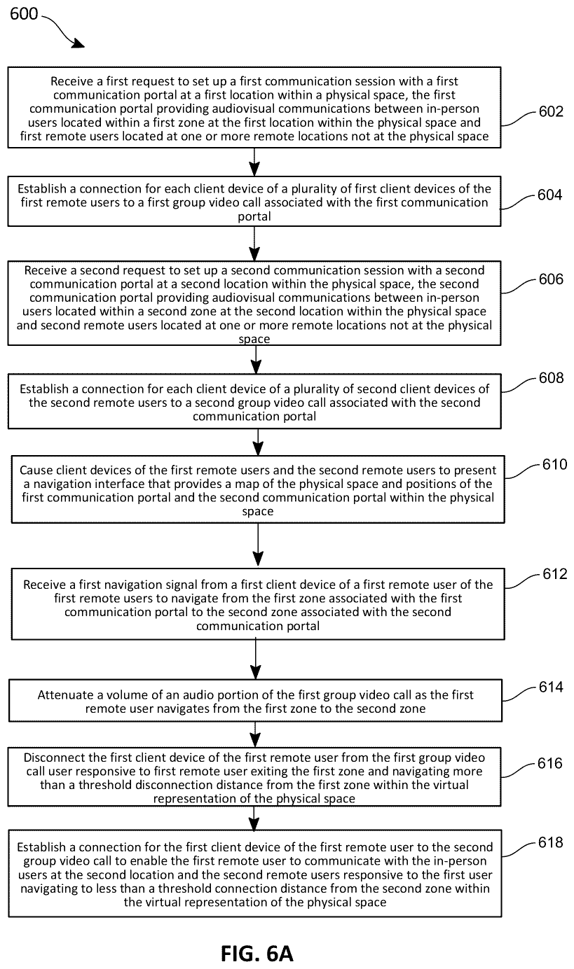

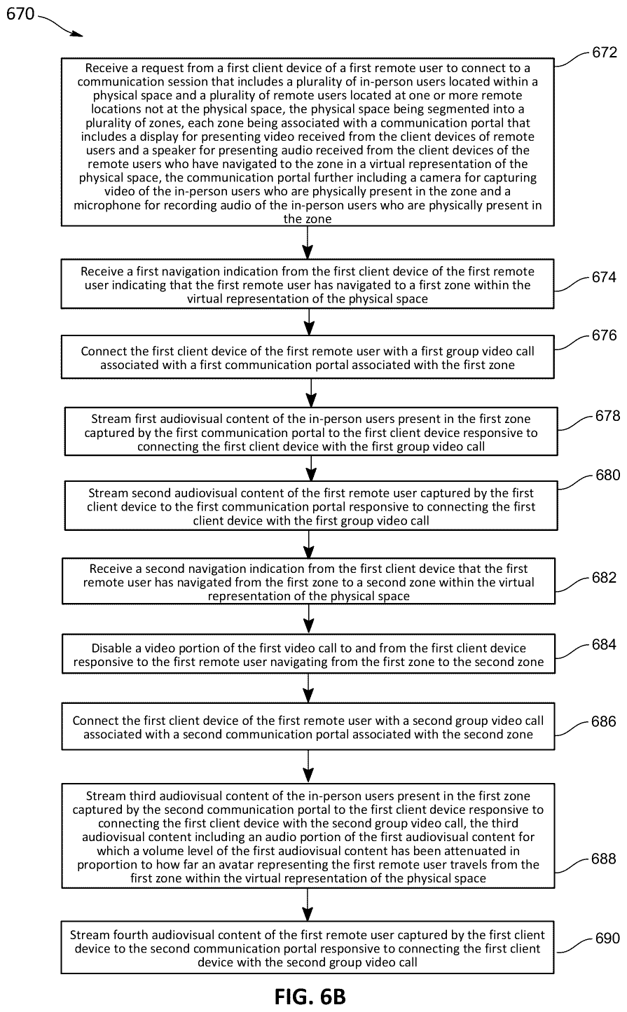

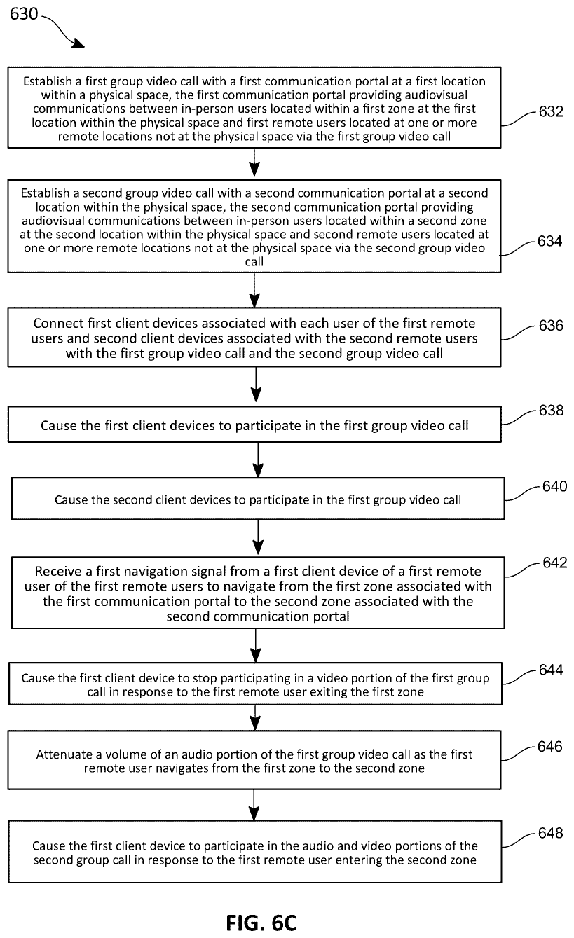

FIG. 6A is an example flow chart of an example process 600 for providing a hybrid environment for interactions between remote and in-person users. The process 600 may be implemented by the communication services platform 110 using the techniques described in the preceding examples.

The process 600 includes an operation 602 of receiving a first request to set up a first communication session with a first communication portal at a first location within a physical space. The first communication portal provides audiovisual communications between in-person users located within a first zone at the first location within the physical space and first remote users located at one or more remote locations not at the physical space. As discussed in the preceding examples, the communication portals 115 are placed at various locations throughout a physical space. The communication portals 115 can send request to the communication services platform 110 to be set up to handle the group video calls that facilitate the mingling of remote and in-person users.

The process 600 includes an operation 604 of establishing a connection for each client device of a plurality of first client devices of the first remote users to a first group video call associated with the first communication portal. The communication services platform 110 facilitates establishing a connection to the group video call associated with the first communication portal as discussed in the preceding examples.

The process 600 includes an operation 606 of receiving a second request to set up a second communication session with a second communication portal at a second location within the physical space. The second communication portal provides audiovisual communications between in-person users located within a second zone at the second location within the physical space and second remote users located at one or more remote locations not at the physical space. As discussed in the preceding examples, each zone has an associated communication portal, and the communication services platform 110 facilitates setting up these communication portals to be able to participate in group video calls with the remote users.

The process 600 includes an operation 608 of establishing a connection for each client device of a plurality of second client devices of the second remote users to a second group video call associated with the second communication portal. The communication services platform 110 facilitates establishing a connection to the group video call associated with the second communication portal as discussed in the preceding examples.

The process 600 includes an operation 610 of causing client devices of the first remote users and the second remote users to present a navigation interface that provides a map of the physical space and positions of the first communication portal and the second communication portal within the physical space. As discussed in the preceding examples, the map interface provides a skeuomorphic map of the physical space. The map interface provides both the in-person users and the remote users with information indicating where the users are located within the environment.

The process 600 includes an operation 612 of receiving a first navigation signal from a first client device of a first remote user of the first remote users to navigate from a zone associated with the first communication portal to a zone associated with the second communication portal. The map interface also enables the remote user to navigate through the virtual representation to visit different zones and engage with other remote users and/or in-person users who are present in those zones.

The process 600 includes an operation 614 of attenuating a volume of an audio portion of the first group video call as the first remote user navigates from the first zone to the second zone. Rather than simply disconnecting the first client device from the first video call, the communication services platform 110 maintains the audio portion of the connection and attenuates the volume of this audio content as the first remote user navigates away from the zone associated with the first group video call. This approach provides an improved sense of spatial awareness and involvement for the remote users, as they are able to hear nearby conversations as would an in-person user who is physically present at the venue.

The process 600 includes an operation 616 of the first client device of disconnecting the first remote user from the first group video call user responsive to first remote user exiting the first zone and navigating more than a threshold disconnection distance from the first zone within the virtual representation of the physical space.

The process 600 includes an operation 618 of establishing a connection for the first client device of the first remote user to the second group video call to enable the first remote user to communicate with the in-person users at the second location and the second remote users responsive to the first user navigating to less than a threshold connection distance from the second zone within the virtual representation of the physical space. The communication services platform 110 automatically facilitates the connection to the second group video call. The threshold connection distance may be determined based on the direction of travel of the first user, the speed at which the first user is navigating through the virtual representation of the physical space, and how long it typically takes the communication services platform 110 to connect a client device to a group video call. The porosity settings associated with the first user may also be taken into account when determining the threshold connection distance, so that the client device 205 of the connection to the group video call can be completed before the user navigates their avatar within the distance from the second zone where they should be able to begin to hear conversations taking place in the second zone as they approach the second zone.

FIG. 6B is an example flow chart of another example process 670 for providing a hybrid environment for interactions between remote and in-person users. The process 670 may be implemented by the communication services platform 110 using the techniques described in the preceding examples.

The process 670 includes an operation 672 of receiving a request from a first client device of a first remote user to connect to a communication session that includes a plurality of in-person users located within a physical space and a plurality of remote users located at one or more remote locations not at the physical space. The physical space is segmented into a plurality of zones, as discussed in the preceding examples. Each zone is associated with a communication portal that includes a display for presenting video received from the client devices of remote users and a speaker for presenting audio received from the client devices of the remote users who have navigated to the zone in a virtual representation of the physical space. The communication portal further including a camera for capturing video of the in-person users who are physically present in the zone and a microphone for capturing audio of the in-person users who are physically present in the zone. In some implementations, the communication services platform 110 can record the video in some implementations as well as video of the remote users to enable users to play back the conversations at a later time. In such implementations, the communication services platform 110 provides means for obtaining user consent for recording and to not record a particular conversion that includes either remote or in-person users who have not consented to recording. The consent for recording may be obtain as the in-person users and/or the remote users join a communication session.

The process 670 includes an operation 674 of receiving a first navigation indication from the first client device of the first remote user indicating that the first remote user has navigated to a first zone within the virtual representation of the physical space.

The process 670 includes an operation 676 of connecting the first client device of the first remote user with a first group video call associated with a first communication portal associated with the first zone. The process 670 includes an operation 678 of streaming first audiovisual content of the in-person users present in the first zone captured by the first communication portal to the first client device responsive to connecting the first client device with the first group video call. This permits the remote user to see and hear the in-person users present in the first zone. The audio and video content from other remote users that are present in the zone are also included in the audio and video content streamed to the client device of the remote user in some implementations.

The process 670 includes an operation 680 of streaming second audiovisual content of the first remote user captured by the first client device to the first communication portal responsive to connecting the first client device with the first group video call. The audio and video content captured by the client device of the remote user is streamed to the communication portal to allow the in-person and other remote users in that zone to see and hear the remote user.

The process 670 includes an operation 682 of receiving a second navigation indication from the first client device that the first remote user has navigated from the first zone to a second zone within the virtual representation of the physical space. The process 670 includes an operation 684 of disabling a video portion of the first video call to and from the first client device responsive to the first remote user navigating from the first zone to the second zone. As discussed in the preceding examples, the video portion of the video call is no longer streamed to the client device of the remote user as they navigate outside of the zone nor is any video input from the client device of the remote user included in the group video call. However, the audio portion of the video call continues to be provided to the client device of the remote user, but the volume of the audio content is attenuated as the remote user navigate farther away from the zone.

The process 670 includes an operation 686 of connecting the first client device of the first remote user with a second group video call associated with a second communication portal associated with the second zone. The communication services platform 110 facilitates connecting the client device of the remote user with the second group call as discussed in the preceding examples.

The process 670 includes an operation 688 of streaming third audiovisual content of the in-person users present in the first zone captured by the second communication portal to the first client device responsive to connecting the first client device with the second group video call. The third audiovisual content includes an audio portion of the first audiovisual content for which a volume level of the first audiovisual content has been attenuated in proportion to how far an avatar representing the first remote user travels from the first zone within the virtual representation of the physical space. As discussed in the preceding examples, the audio from the zone that the user is leaving and/or other zones proximate to the remote user may be attenuated and provided in the audio stream provided to the client device of the remote user. This approach promotes situational awareness and immersion by allowing the remote user to hear nearby conversations, which is not possible with current communications platforms which are closed environments that only stream content to those who have been invited to participate in a video meeting.

The process 670 includes an operation 690 of streaming fourth audiovisual content of the first remote user captured by the first client device to the second communication portal responsive to connecting the first client device with the second group video call. The audio and video captured by the client device of the user is streamed to the communication portal to permit any remote user accessing that communication portal or an in-person user proximate to the portal to see and hear the first remote user.

FIG. 6C is an example flow chart of another example process 630 for providing a hybrid environment for interactions between remote and in-person users. The process 630 may be implemented by the communication services platform 110 using the techniques described in the preceding examples.

The process 630 includes an operation 632 of establishing a first group video call with a first communication portal at a first location within a physical space. The first communication portal 115a provides audiovisual communications between in-person users located within a first zone at the first location within the physical space and first remote users located at one or more remote locations not at the physical space via the first group video call. As discussed in the preceding examples, each of the communication portals 115 are associated with a group video call. These calls are set up with the communication services platform 110 before a communication session that facilitates the hybrid environment for interactions between remote and in-person users. The group video call associated with each communication portal 115a is started with the communication portal 115 associated with each zone before the client devices 105 of the remote users can begin to connect with these calls. In the example process described in FIG. 6C, the first remote users are connected with the first communication portal 115a initially but could be connected with a different communication portal 115 within the physical space in other implementations. For example, some implementations may initially connect users with a communication portal 115 in a round robin approach, based on the number of users currently connected to each of the communication portals 115, whether there are any in-person users present at a particular communication portal, and/or based on other factors.

The process 630 includes an operation 634 of establishing a second group video call with a second communication portal at a second location within the physical space. The second communication portal providing audiovisual communications between in-person users located within a second zone at the second location within the physical space and second remote users located at one or more remote locations not at the physical space via the second group video call. The second group video call is set up in a manner similar to that of the first group video call in operation 632.

The process 630 includes an operation 636 of connecting first client devices associated with each user of the first remote users and second client devices associated with the second remote users with the first group video call and the second group video call. As discussed in the preceding examples, the communication services platform 110 connects the client devices 105 of the remote users to all of the group video calls associated with the communication portals 115 in the physical environment. However, in other implementations, the communication services platform 110 implements dynamic call management to limit the number of group video calls to which each client device 105 by selectively connecting to and/or disconnecting from group video calls to reduce the computing and network resources utilized. Another benefit of this approach is that the number of communication portals 115 that may be included in communication session associated with a physical space may be increased without significantly increasing the computational resources and networking resources required to support the additional communication portals 115.

The process 630 includes an operation 638 of causing the first client devices to participate in the first group video call and an operation 640 of causing the second client devices to participate in the first group video call. As discussed in the preceding examples, while the client devices 105 may be connected with all of the group video calls associated with the communication session, the client device 105 of each of the remote users does not actively participate in all of these calls. Instead, the communication services platform 110 captures video content

The process 630 includes an operation 642 of receiving a first navigation signal from a first client device of a first remote user of the first remote users to navigate from the first zone associated with the first communication portal to the second zone associated with the second communication portal. As discussed in the preceding examples, a remote user may navigate through the virtual representation of the physical space using the map interface.

The process 630 includes an operation 644 of causing the first client device 105 to stop participating in a video portion of the first group call in response to the first remote user exiting the first zone. As the first remote user navigates out of the first zone, the client device 105 no participates in the video portion of the group video call associated with the first communication portal.

The process 630 includes an operation 646 of attenuating a volume of an audio portion of the first group video call as the first remote user navigates from the first zone to the second zone. The first client device 105 no longer contributes audio content to the group video call either but may continue to receive audio content associated with the group video call based on the audio porosity settings. As the first remote user navigates their avatar further away from the first zone, the volume associated with the first group video call provided to the first client device 105 of the first remote user is decreased by the communication services platform 110 and/or the client device 105 of the user. Once the first remote user has navigated their avatar beyond a threshold distance from the first zone, the first client device 105 of the first user no longer receives any audio content contribution from the first zone, unless the user navigates back toward the first zone. However, the client device 105 of the first remote user remains connected to the first group video to enable the client device 105 to participate in the call should the user navigate back toward the first zone.

The process 630 includes an operation 648 of causing the first client device to participate in the audio and video portions of the second group call in response to the first remote user entering the second zone. As discussed in the preceding examples, the client devices of the users participating in a communication session are automatically connected with all of the group video calls associated with the communication session. As the user navigates their avatar into the second zone, the client device 105 of the first remote user is able to participate in the second group video call by providing audio and/or video content.

The detailed examples of systems, devices, and techniques described in connection with FIGS. 1-6C are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6C are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

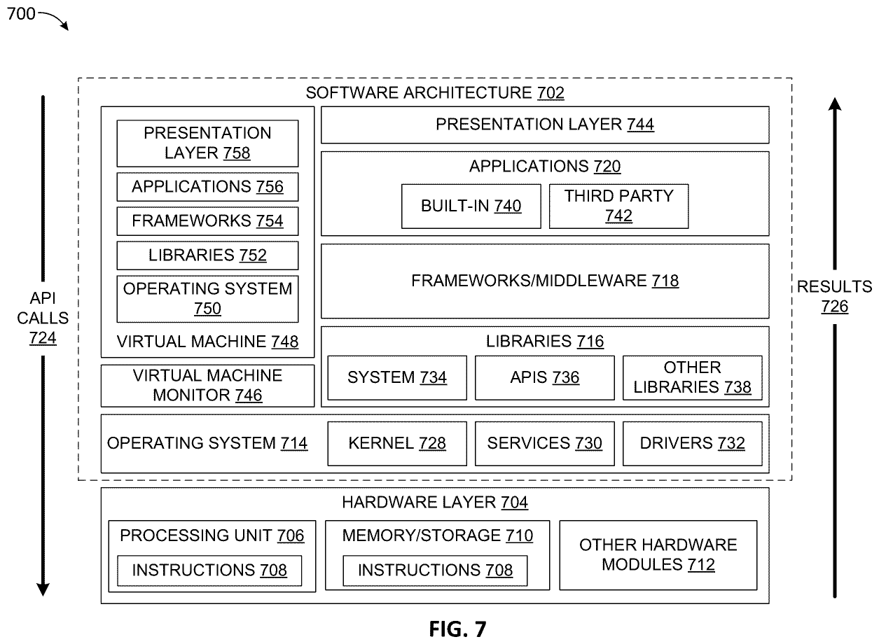

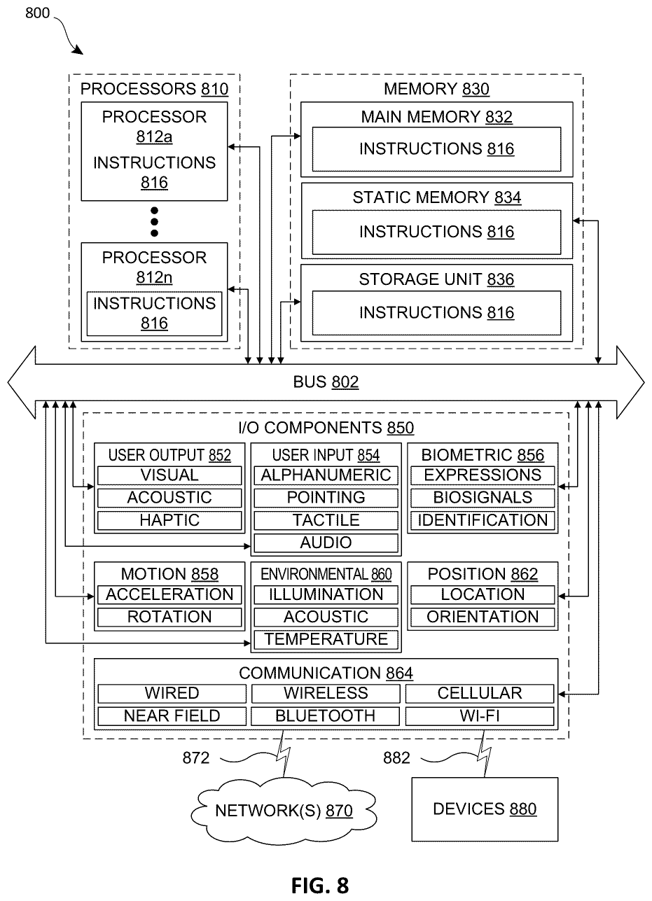

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
establishing a first group video call with a first communication portal at a first location within a physical space, the first communication portal providing audiovisual communications between in-person users located within a first zone at the first location within the physical space and first remote users located at one or more remote locations not at the physical space via the first group video call;
establishing a second group video call with a second communication portal at a second location within the physical space, the second communication portal providing audiovisual communications between in-person users located within a second zone at the second location within the physical space and second remote users located at one or more remote locations not at the physical space via the second group video call;
connecting first client devices associated with each user of the first remote users and second client devices associated with the second remote users with the first group video call and the second group video call;
causing the first client devices to participate in the first group video call;
causing the second client devices to participate in the first group video call;
receiving a first navigation signal from a first client device of a first remote user of the first remote users to navigate from the first zone associated with the first communication portal to the second zone associated with the second communication portal;
causing the first client device to stop participating in a video portion of the first group call in response to the first remote user exiting the first zone;
attenuating a volume of an audio portion of the first group video call as the first remote user navigates from the first zone to the second zone; and
causing the first client device to participate in the audio and video portions of the second group call in response to the first remote user entering the second zone.

2. The data processing system of claim 1, wherein the machine-readable storage medium further includes instructions configured to cause the processor to perform operations of:
causing client devices of the first remote users and the second remote users to present a navigation interface that provides a map of the physical space and positions of the first communication portal and the second communication portal within the physical space.

3. The data processing system of claim 1, wherein the machine-readable storage medium further includes instructions configured to cause the processor to perform operations of:
causing the client devices of the first remote users and the second remote users to present a neighborhood view pane that includes an indication of how far avatars of other users proximate are from an avatar of a respective remote user associated with the client device.

4. The data processing system of claim 1, wherein the machine-readable storage medium further includes instructions configured to cause the processor to perform operations of:
obtaining a group call identifier of the second group video call associated with the second communication portal from a call mapping datastore stored in a persistent memory of the data processing system; and
establishing the connection with the first client device to the second group video call using the group call identifier.

5. The data processing system of claim 1, wherein the first navigation signal identifies a path taken on the navigation interface, the path indicating the path that an avatar representing the first remote user takes through a virtual representation of the physical space.

6. The data processing system of claim 1, wherein the machine-readable storage medium further includes instructions configured to cause the processor to perform operations of:
causing the first communication portal and the second communication portal to present a second navigation interface that provides a map of the physical space is a skeuomorphic representation of the physical space and positions of the first communication portal and the second communication portal within the physical space;
tracking movement of in-person users through the physical space and movement of the remote users through a virtual representation of the physical space; and
updating the location of first avatars representing the in-person users on the navigation interface based on the movement of the in-person users through the physical space; and
updating the location of second avatars representing the remote users on the navigation interface based on the movement of the remote users through the virtual representation of the physical space.

7. The data processing system of claim 1, wherein the machine-readable storage medium further includes instructions configured to cause the processor to perform operations of:
performing a liveliness check on a video stream received from each client device of the plurality of first client devices; and
rejecting the connection for any client device for which the video stream fails the liveliness check.

8. The data processing system of claim 1, wherein performing the liveliness check includes performing one or more of a face detections check, a face-spoofing check, and an eye-mouth movement detection check.

9. The data processing system of claim 1, wherein the machine-readable storage medium further includes instructions configured to cause the processor to perform operations of:
analyzing a video stream captured by a camera of the first communication portal using a presence detection model trained to output an indication whether there are any in-person users within a field of view (FOV) of the camera; and
automatically muting a microphone and a speaker of the first communication portal responsive to determining that no in-person users are within the FOV of the camera.

10. The data processing system of claim 1, wherein the machine-readable storage medium further includes instructions configured to cause the processor to perform operations of:
attenuating the volume of the audio portion of the first group video call as the first remote user navigates from the first zone to the second zone based on a distance an avatar representing the first user is from the first zone, obstructions between a location of the first remote user and the first zone, or a combination thereof.

11. A method implemented in a data processing system for providing a hybrid environment for interactions between remote and in-person users, the method comprising:
receiving a first request to set up a first communication session with a first communication portal at a first location within a physical space, the first communication portal providing audiovisual communications between in-person users located within a first zone at the first location within the physical space and first remote users located at one or more remote locations not at the physical space;
establishing a connection for each client device of a plurality of first client devices of the first remote users to a first group video call associated with the first communication portal;
receiving a second request to set up a second communication session with a second communication portal at a second location within the physical space, the second communication portal providing audiovisual communications between in-person users located within a second zone at the second location within the physical space and second remote users located at one or more remote locations not at the physical space;
establishing a connection for each client device of a plurality of second client devices of the second remote users to a second group video call associated with the second communication portal;
causing client devices of the first remote users and the second remote users to present a navigation interface that provides a virtual representation of the physical space comprising map of the physical space and positions of the first communication portal and the second communication portal within the physical space;
receiving a first navigation signal from a first client device of a first remote user of the first remote users to navigate from the first zone associated with the first communication portal to the second zone associated with the second communication portal;
attenuating a volume of an audio portion of the first group video call as the first remote user navigates from the first zone to the second zone;
disconnecting the first remote user from the first group video call user responsive to first remote user exiting the first zone and navigating more than a threshold disconnection distance from the first zone within the virtual representation of the physical space; and
establishing a connection for the first client device of the first remote user to the second group video call to enable the first remote user to communicate with the in-person users at the second location and the second remote users responsive to the first user navigating to less than a threshold connection distance from the second zone within the virtual representation of the physical space.

12. The method of claim 11, further comprising:
obtaining a group call identifier of the second group video call associated with the second communication portal from a call mapping datastore stored in a persistent memory of the data processing system; and
establishing the connection with the first client device to the second group video call using the group call identifier.

13. The method of claim 11, wherein the first navigation signal identifies a path taken on the navigation interface, the path indicating the path that an avatar representing the first remote user takes through a virtual representation of the physical space.

14. The method of claim 11, further comprising:
causing the first communication portal and the second communication portal to present a second navigation interface that provides a map of the physical space is a skeuomorphic representation of the physical space and positions of the first communication portal and the second communication portal within the physical space;
tracking movement of in-person users through the physical space and movement of the remote users through a virtual representation of the physical space; and
updating the location of first avatars representing the in-person users on the navigation interface based on the movement of the in-person users through the physical space; and
updating the location of second avatars representing the remote users on the navigation interface based on the movement of the remote users through the virtual representation of the physical space.

15. The method of claim 11, further comprising:
performing a liveliness check on a video stream received from each client device of the plurality of first client devices; and
rejecting the connection for any client device for which the video stream fails the liveliness check.

16. The method of claim 11, wherein performing the liveliness check includes performing one or more of a face detections check, a face-spoofing check, and an eye-mouth movement detection check.

17. A data processing system comprising:
a processor; and
a machine-readable storage medium storing executable instructions that, when executed, cause the processor to perform operations of:
receiving a request from a first client device of a first remote user to connect to a communication session that includes a plurality of in-person users located within a physical space and a plurality of remote users located at one or more remote locations not at the physical space, the physical space being segmented into a plurality of zones, each zone being associated with a communication portal that includes a display for presenting video received from the client devices of remote users and a speaker for presenting audio received from the client devices of the remote users who have navigated to the zone in a virtual representation of the physical space, the communication portal further including a camera for capturing video of the in-person users who are physically present in the zone and a microphone for capturing audio of the in-person users who are physically present in the zone;
receiving a first navigation indication from the first client device of the first remote user indicating that the first remote user has navigated to a first zone within the virtual representation of the physical space;
connecting the first client device of the first remote user with a first group video call associated with a first communication portal associated with the first zone;
streaming first audiovisual content of the in-person users present in the first zone captured by the first communication portal to the first client device responsive to connecting the first client device with the first group video call;
streaming second audiovisual content of the first remote user captured by the first client device to the first communication portal responsive to connecting the first client device with the first group video call;
receiving a second navigation indication from the first client device that the first remote user has navigated from the first zone to a second zone within the virtual representation of the physical space;
disabling a video portion of the first video call to and from the first client device responsive to the first remote user navigating from the first zone to the second zone;
connecting the first client device of the first remote user with a second group video call associated with a second communication portal associated with the second zone;
streaming third audiovisual content of the in-person users present in the first zone captured by the second communication portal to the first client device responsive to connecting the first client device with the second group video call, the third audiovisual content including an audio portion of the first audiovisual content for which a volume level of the first audiovisual content has been attenuated in proportion to how far an avatar representing the first remote user travels from the first zone within the virtual representation of the physical space; and
streaming fourth audiovisual content of the first remote user captured by the first client device to the second communication portal responsive to connecting the first client device with the second group video call.

18. The data processing system of claim 17, wherein the machine-readable storage medium further includes instructions configured to cause the processor to perform operations of:
obtaining a group call identifier of the first group video call associated with the first communication portal from a call mapping datastore stored in a persistent memory of the data processing system; and wherein
establishing the connection with the first client device to the second group video call using the group call identifier.

19. The data processing system of claim 17, wherein the second navigation indication identifies a path taken on a navigation interface, the path indicating the path that an avatar representing the first remote user takes through the virtual representation of the physical space.

20. The data processing system of claim 17, wherein the machine-readable storage medium further includes instructions configured to cause the processor to perform operations of:
causing the first communication portal and the second communication portal to present a second navigation interface that provides a map of the physical space is a skeuomorphic representation of the physical space and positions of the first communication portal and the second communication portal within the physical space;
tracking movement of the in-person users through the physical space and movement of the remote users through the virtual representation of the physical space; and
updating the location of first avatars representing the in-person users on the navigation interface based on the movement of the in-person users through the physical space; and
updating the location of second avatars representing the remote users on the navigation interface based on the movement of the remote users through the virtual representation of the physical space.
